(19) United States
(12) Patent Application Publication
(10) Pub. No.: US 2024/0361773 A1
(43) Pub. Date: Oct. 31, 2024

(54) CONTROL SYSTEM, CONTROL METHOD, AND STORAGE MEDIUM

(71) Applicant: CANON KABUSHIKI KAISHA, Tokyo (JP)

(72) Inventors: Masatoshi OTSUBO, Tochigi (JP); Chiyako NAKAJIMA, Kanagawa (JP)

(21) Appl. No.: 18/642,876

(22) Filed: Apr. 23, 2024

(30) Foreign Application Priority Data
Apr. 28, 2023 (JP) 2023-074797

(51) Int. Cl. G05D 1/226; G05D 1/224; G05D 1/246

(52) U.S. Cl. CPC G05D 1/226; G05D 1/2462; G05D 1/2246

(57) ABSTRACT

In a control system comprising, a control unit configured to issue a control instruction to at least one autonomous movable apparatus, and a conversion information holding unit configured to convert spatial information including information on a type of an object that is present in a space defined by latitude, longitude, and height and information on time into a format in association with a first unique identifier and hold the spatial information are provided, and the first unique identifier is stored so that information on a second unique identifier that is different from the first unique identifier and is associated with the first unique identifier can be referred to.

### BACKGROUND OF THE INVENTION

### Field of the Invention

The present invention relates to a control system, a control method, a storage medium, and the like.

### Description of the Related Art

In recent years, development of an overall image (hereinafter, referred to as a “digital architecture”) that connects data and systems among members of different organizations and societies has advanced globally with technical innovation such as autonomous traveling mobility and a space recognition system.

By utilizing the digital architecture, the autonomous traveling mobility and the space recognition system can acquire more information, and can solve a larger problem in cooperation with external devices and systems other than one's own autonomous traveling mobility and the space recognition system. For the purpose of realizing this, a technology for connecting the space of the real world and the digital information is required.

As a technology for combining space of the real world and digital information, according to Japanese Patent Application No. 2012-136855, a single processor divides a space-time region into a space and a time according to space-time management data provided by a user to generate a plurality of space-time divided regions.

Additionally, an identifier expressed by a one dimensional integer value is assigned in order to uniquely identify each of a plurality of space-time division regions is assigned in consideration of temporal and spatial neighborhoods of the time-space division regions. Then, a space-time data management system that determines the arrangement of time-series data such that data in a space-time division region having a close identifier is arranged close to each other on a storage device is disclosed.

However, the technique of the above Japanese Patent Application No. 2012-136855 does not refer to the generation rule of the space-time division region, and the data related to the generated region can be grasped by the identifier only in the processor that has generated it.

Hence, in order to share and use the data among different system users, it is necessary for each system user to understand the structure of the data in advance and then reconstruct the existing system so that the data structure can be handled by the system user, which may cause a large amount of work. Note that the system user is, for example, a member of an organization and a society.

Additionally, in the prior art, a specific usage method for different system users to use the information on the space-time division region is not mentioned.

### SUMMARY OF THE INVENTION

A control system comprising: at least one processor or circuit configured to function as: a control unit configured to issue a control instruction to at least one autonomous movable apparatus; and a conversion information holding unit configured to convert spatial information including information on a type of an object that is present in a space defined by latitude, longitude, and height and information on time into a format in association with a first unique identifier and hold the spatial information, wherein the first unique identifier is stored so that information on a second unique identifier that is different from the first unique identifier and is associated with the first identifier can be referred to.

Further features of the present invention will become apparent from the following description of embodiments with reference to the attached drawings.

### BRIEF DESCRIPTION OF THE DRAWINGS

FIG. 1 is a diagram showing an example of an overall configuration of an autonomous movable apparatus control system according to the first embodiment of the present invention.

FIG. 2A is a diagram showing an example of an input screen when the user inputs position information, and FIG. 2B is a diagram showing an example of a selection screen for selecting an autonomous movable apparatus to be used.

FIG. 3A is a diagram showing an example of a screen for confirming the current position of the autonomous movable apparatus, and FIG. 3B is a diagram showing an example of a map display screen when the current position of the autonomous movable apparatus is confirmed.

FIG. 4 is a block diagram showing an example of the internal configuration of each device in FIG. 1.

FIG. 5A is a diagram showing a spatial positional relation between an autonomous movable apparatus 12 and a column 99 serving as feature information of the vicinity thereof in the real world. FIG. 5B is a diagram showing a state in which the autonomous movable apparatus 12 and the column 99 are mapped in an arbitrary XYZ coordinate system space with P0 as an origin.

FIG. 6 is a perspective view showing an example of a mechanical configuration of the autonomous movable apparatus 12 according to the first embodiment.

FIG. 7 is a block diagram showing a specific example of the hardware configuration of a control unit 10-2, a control unit 11-2, a control unit 12-2, a control unit 13-2, a control unit 14-2, and a control unit 15-2.

FIG. 8 is a sequence diagram that explains a process executed by the autonomous movable apparatus control system according to the first embodiment.

FIG. 9 is a sequence diagram continued from FIG. 8.

FIG. 10 is a sequence diagram continued from FIG. 9.

FIG. 11A is a diagram showing latitude/longitude information of the earth, and FIG. 11B is a perspective view showing a predetermined space 100 of FIG. 11A.

FIG. 12 is a diagram schematically showing spatial information in the space 100.

FIG. 13A is a diagram in which path information is displayed by map information, FIG. 13B is a diagram in which path information using position point group data is displayed by map information, and FIG. 13C is a diagram in which path information using a unique identifier is displayed by map information.

FIG. 14 is a diagram that explains how data is stored in the format database 14-4.

FIG. 15A and FIG. 15B are diagrams that explain a blind spot accident.

FIG. 16A and FIG. 16B are top views of an intersection.

FIG. 17A and FIG. 17B are diagrams when the information currently held by the format database 14-4 is mapped.

FIG. 18 is a diagram explaining a format that stores completed data.

FIG. 19 is a diagram that explains a sequence in which a conversion information holding device 14 updates the result of the associated unique identifier list header associated with the unique identifier of the right turn lane.

FIG. 20 is a diagram that explains a sequence in which the conversion information holding device 14 updates the result of the associated unique identifier list header associated with the unique identifier of the right turn lane, and shows a continuation of FIG. 19.

FIG. 21 is a diagram that explains sequence executed by the control unit 12-2 of the autonomous movable apparatus 12.

FIG. 22 is a diagram that explains an overview of a prior information detection method.

FIG. 23 is a diagram that explains the result types of the associated unique identifier list header including the blind spot accident reduction method.

FIG. 24 is a diagram that explains a sequence in which result numbers 3 and 4 are determined by the prior information detection method.

FIG. 25 is a diagram that explains a sequence executed by the control unit 12-2 of the autonomous movable apparatus 12 in the method of detecting route information in advance.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified. Although, in the embodiments, an example in which the present invention is applied to control of an autonomous movable apparatus will be explained, the movable apparatus may be a movable apparatus at least a part of which can be operated by a user with respect to movement of the movable apparatus. That is, for example, a configuration may be adopted in which various displays and the like regarding the movement path and the like are performed for the user, and the user performs a part of the driving operation of the movable apparatus by referencing the display.

### First Embodiment

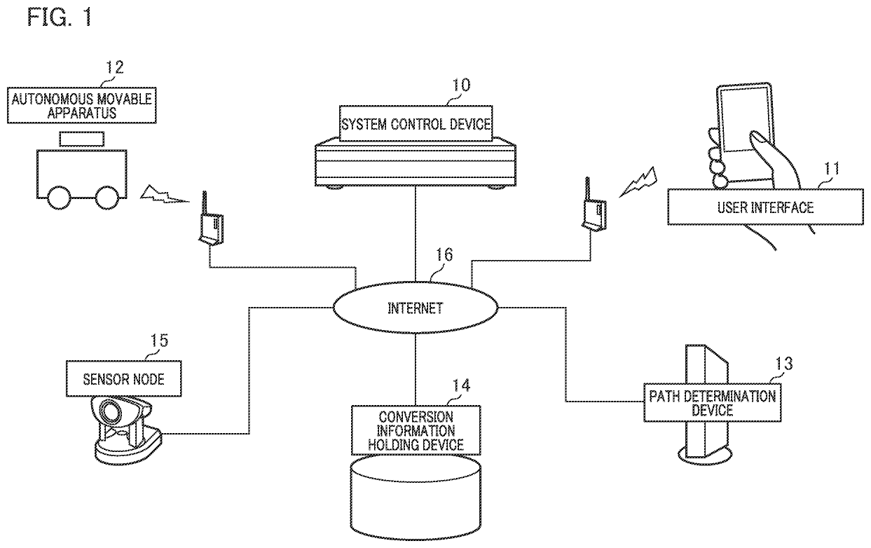

FIG. 1 is a diagram showing an example of the overall configuration of an autonomous movable apparatus control system according to the first embodiment of the present invention.

As shown in FIG. 1, the autonomous movable apparatus control system (which may be abbreviated “control system”) of the first embodiment includes a system control device 10, a user interface 11, the autonomous movable apparatus 12, a path determination device 13, the conversion information holding device 14, a sensor node 15, and the like. Note that, here, the user interface 11 denotes a user terminal device. The system control device 10 is an example of an information processing apparatus.

Note that, in the first embodiment, each of the devices as shown in FIG. 1 are connected to each other via the Internet 16 by each of the network connection units to be described below. However, another network system, for example, a local area network (LAN) may be used.

Additionally, a part of the system control device 10, the user interface 11, the path determination device 13, the conversion information holding device 14, and the like may be configured as the same device.

Each of the system control device 10, the user interface 11, the autonomous movable apparatus 12, the path determination device 13, the conversion information holding device 14, and the sensor node 15 includes an information processing apparatus consisting of a CPU serving as a computer, a ROM, a RAM, and an HDD serving as a storage media. Details of functions and internal configurations of each device will be described below.

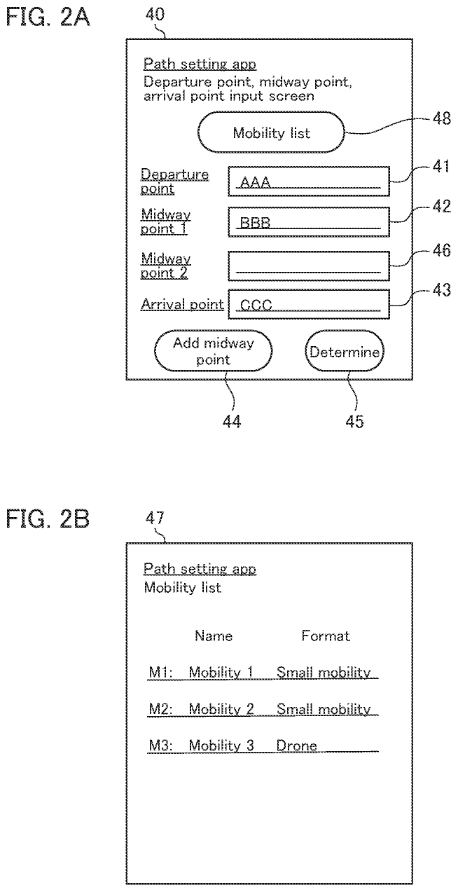

Next, service application software (hereinafter, abbreviated “application”) provided by the autonomous movable apparatus control system will be explained. Note that, in the explanation, first, a screen image displayed on the user interface 11 when the user inputs position information will be explained with reference to FIG. 2A and FIG. 2B.

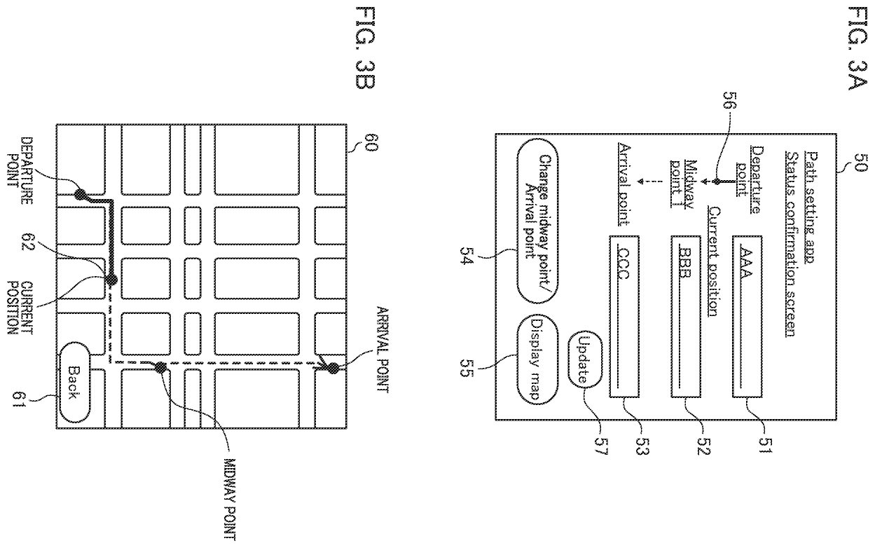

Next, a screen image displayed on the user interface 11 when the user browses the current position of the autonomous movable apparatus 12 will be explained with reference to FIG. 3A and FIG. 3B. With these explanations, how the application is operated in the autonomous movable apparatus control system will be explained using an example.

Note that although, in the explanation, for convenience, the map display is explained using a two dimensional plane, in the first embodiment, the user can specify a three dimensional position including “height”, and can input “height” information. That is, a three-dimensional map can be generated according to the first embodiment.

FIG. 2A is a diagram illustrating an example of an input screen when a user inputs position information, and FIG. 2B is a diagram illustrating an example of a selection screen for selecting an autonomous movable apparatus to be used. When the user operates the display screen of the user interface 11 to access the Internet 16 and select, for example, a path setting application of the autonomous movable apparatus control system, a WEB page of the system control device 10 is displayed.

What is first displayed on the WEB page is an input screen 40 for a departure point, a midway point, and an arrival point for setting the departure point, the midway point, and the arrival point when the autonomous movable apparatus 12 is moved. The input screen 40 has a list display button 48 for displaying a list of the autonomous mobile bodies (mobilities) to be used, and when the user presses the list display button 48, a list display screen 47 of the mobilities is displayed as shown in FIG. 2B.

First, the user selects an autonomous movable apparatus (mobility) to be used on the list display screen 47. Although, on the list display screen 47, for example, the mobilities from M1 to M3 are displayed in a selectable manner, the number is not limited thereto.

When the user selects one of the mobilities from M1 to M3 by a click operation and the like, the screen automatically returns to the input screen 40 of FIG. 2A. Additionally, the selected mobility name is displayed on the list display button 48.

Subsequently, the user inputs a place to be set as a departure point in an input field 41 of “departure point”. Additionally, the user inputs a place to be set as a midway point in the input field 42 of “midway point 1”. Note that a midway point can be added, and when an add button 44 of a midway point is pressed once, an input field 46 of “midway point 2” is additionally displayed, and a midway point to be added can be input.

Every time the add button 44 for a midway point is pressed, the input field 46 is additionally displayed such as “midway point 3” and “midway point 4”, and a plurality of midway points to be added can be input. Additionally, the user inputs a place to be set as an arrival point to an input field 43 of “arrival point”. Note that although not shown in the drawings, when the input fields 41 to 43, 46, and the like are clicked, a keyboard and the like for inputting characters is temporarily displayed, and a desired character can be input.

Then, the user can set the movement path of the autonomous movable apparatus 12 by pressing a determination button 45. In the example of FIG. 2, “AAA” is set as the departure point, “BBB” is set as the midway point 1, and “CCC” is set as the arrival point. The words to be input in the input field may be, for example, an address and the like, or position information for indicating a specific position such as latitude/longitude information, a store name and a phone number may be input.

FIG. 3A is a diagram showing an example of a screen for confirming the current position of an autonomous movable apparatus, and FIG. 3B is a diagram showing an example of a map display screen when the current position of the autonomous movable apparatus is confirmed.

Reference numeral 50 in FIG. 3A denotes a confirmation screen, and is displayed by operating an operation button (not illustrated) after setting the moving path of the autonomous movable apparatus 12 on a screen as shown in FIG. 2A. On the confirmation screen 50, the current position of the autonomous movable apparatus 12 is displayed on the web page of the user interface 11, for example, similar to a current position 56. Thereby, the user can easily grasp the current location.

Additionally, the user can update the screen display information to display the latest state by pressing the update button 57. Additionally, the user can change the departure point, the midway point, and the arrival point by pressing down a midway point/arrival point change button 54. That is, the user can change the departure point, the midway point, and the arrival point by inputting a place to be re-set to each of an input field 51 of “departure point”, an input field 52 of “midway point 1”, and an input field 53 of “arrival point”.

In FIG. 3B, an example of a map display screen 60 is shown that is switched from the confirmation screen 50 when a map display button 55 of FIG. 3A is pressed. On the map display screen 60, the position of a current position 62 is displayed on the map, thereby allowing the current position of the autonomous mobile body 12 to be more easily confirmed. Additionally, when the user presses a return button 61, the display screen can be returned to the confirmation screen 50 of FIG. 3A.

As described above, the user can easily set the moving path for moving the autonomous movable apparatus 12 from a predetermined place to another predetermined place by operating the user interface 11. Note that such a path setting application can also be applied to, for example, a taxi dispatch service, a drone home delivery service, and the like.

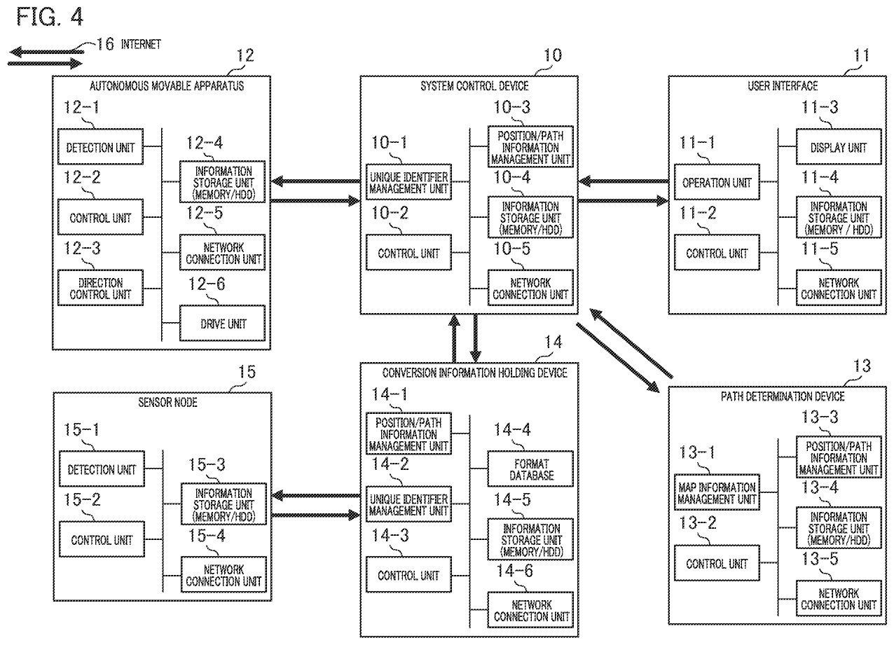

Next, a configuration example and a function example of each of the devices 10 to 15 in FIG. 1 will be explained in detail with reference to FIG. 4. FIG. 4 is a block diagram illustrating an internal configuration example of each of the devices in FIG. 1.

In FIG. 4, the user interface 11 includes an operation unit 11-1, the control unit 11-2, a display unit 11-3, an information storage unit (memory/HDD) 11-4, and a network connection unit 11-5. The operation unit 11-1 is configured by a touch panel, key buttons, and the like, and is used to input data. The display unit 11-3 is, for example, a liquid crystal screen and the like, and is used to display path information and other data.

The display screen of the user interface 11 as shown in FIG. 2 and FIG. 3 is displayed on the display unit 11-3. The user can select a path, input information, confirm information, and the like using the menu displayed on the display unit 11-3.

That is, the operation unit 11-1 and the display unit 11-3 provide an operation interface for the user to actually perform an operation. Note that instead of separately providing the operation unit 11-1 and the display unit 11-3, a touch panel may be used as both the operation unit and the display unit.

The control unit 11-2 contains a CPU serving as a computer, manages various applications in the user interface 11, manages modes such as information input and information confirmation, and controls communication processing. Additionally, it also controls processing in each unit in the system control device.

The information storage unit (memory/HDD) 11-4 is, for example, a database for storing necessary information such as computer programs and the like to be executed by the CPU. The network connecting unit 11-5 controls communication performed via the Internet, LAN, and a wireless LAN. Note that the user interface 11 may be a device such as a smartphone or may be in the form of a tablet terminal.

Thus, the user interface 11 of the first embodiment displays the input screen 40 for inputting the departure point, the midway point, and the arrival point on the browser screen of the system control device 10, and enables the user to input the position information such as the departure point, the midway point, and the arrival point. Furthermore, by displaying the confirmation screen 50 and the map display screen 60 on the browser screen, the current position of the autonomous movable apparatus 12 can be displayed.

The path determination device 13 in FIG. 4 is provided with a map information management unit 13-1, the control unit 13-2, a position/path information management unit 13-3, an information storage unit (memory/HDD) 13-4, and a network connection unit 13-5.

The map information management unit 13-1 has wide-area map information, searches for path information indicating a route on a map based on specified predetermined position information, and transmits the path information of the search result to the position/path information management unit 13-3.

The map information is three dimensional map information including information such as terrain and latitude/longitude/altitude, and also includes regulatory information related to the road traffic law including driveways, sidewalks, traveling directions, and traffic regulations.

Additionally, regulation information that changes with time, such as a one way road depending on a time zone and a pedestrian road depending on a time zone, is also included together with each piece of time information. The control unit 13-2 includes a CPU serving as a computer, and controls processing in each unit in the path determination device 13.

The position/path information management unit 13-3 manages the position information of the autonomous movable apparatus acquired via the network connection unit 13-5, transmits the position information to the map information management unit 13-1, and manages the path information as the search result acquired from the map information management unit 13-1. The control unit 13-2 converts the path information managed by the position/path information management unit 13-3 into a predetermined data format in response to a request from the external system, and transmits the path information to the external system.

As described above, in the first embodiment, the path determination device 13 is configured such that a path conforming to the road traffic law and the like is searched for based on the specified position information, and the path information is output in a predetermined data format.

The conversion information holding device 14 in FIG. 4 is provided with a position/path information management unit 14-1, a unique identifier management unit 14-2, a control unit 14-3, a format database 14-4, an information storage unit (memory/HDD) 14-5, and a network connection unit 14-6.

The position/path information management unit 14-1 manages predetermined position information acquired through the network connection unit 14-6, and transmits the position information to the control unit 14-3 in response to a request from the control unit 14-3. The control unit 14-3 contains a CPU serving as a computer, and controls processing in each unit in the conversion information holding device 14.

The control unit 14-3 converts the position information into a unique identifier defined by the format, based on the position information acquired from the position/path information management unit 14-1 and the format information managed by the format database 14-4.

In addition, it transmits the information to the unique identifier management unit 14-2. Although the format will be explained in detail below, an identifier (hereinafter referred to as a “unique identifier”) is assigned to a space having a predetermined position as a start point, and the space is managed by the unique identifier. In the first embodiment, a corresponding unique identifier and information in a space can be acquired based on predetermined position information.

The unique identifier management unit 14-2 manages the unique identifier converted by the control unit 14-3 and transmits the unique identifier through the network connection unit 14-6. The format database 14-4 manages the information on the format, and transmits the information on the format to the control unit 14-3 according to a request of the control unit 14-3.

Additionally, the information in the space acquired through the network connection unit 14-6 is managed by using the format. The conversion information holding device 14 manages the information on the space acquired by the external device, device, and network by associating these with the unique identifier. Additionally, the conversion information holding device 14 provides the unique identifier and information related to the space associated with the unique identifier to an external device, device, and network.

As described above, the conversion information holding device 14 acquires the unique identifier and the information in the space based on the predetermined position information, and manages and provides this information in a state in which the information can be shared by an external device, device, and network connected to the conversion information holding device 14.

In addition, the conversion information holding device 14 converts the position information specified by the system control device 10 into the unique identifier, and provides the unique identifier to the system control device 10.

In FIG. 4, the system control device 10 is provided with a unique identifier management unit 10-1, the control unit 10-2, a position/path information management unit 10-3, an information storage unit (memory/HDD) 10-4, and a network connection unit 10-5. The position/path information management unit 10-3 holds simple map information in which terrain information and latitude/longitude information are associated with each other, and manages predetermined position information and path information acquired through the network connection unit 10-5.

Additionally, the position/path information management unit 10-3 can divide the path information at predetermined intervals, and generate position information such as latitudes/longitudes of the divided places. The unique identifier management unit 10-1 manages information obtained by converting the position information and the path information into the unique identifier.

The control unit 10-2 has a built-in CPU serving as a computer, and it controls the communication function of the position information, the path information, and the unique identifier of the system control device 10, and controls the processing in each unit in the system control device 10.

Additionally, the control unit 10-2 provides a WEB page to the user interface 11, and transmits predetermined position information acquired from the WEB page to the path determination device 13. Additionally, it acquires predetermined path information from the path determination device 13, and transmits each piece of position information of the path information to the conversion information holding device 14. Then, it transmits path information converted into a unique identifier acquired from the conversion information holding device 14 to the autonomous movable apparatus 12.

As described above, the system control device 10 is configured to be capable of acquiring predetermined position information specified by the user, transmitting and receiving the position information and path information, generating position information, and transmitting and receiving the path information using a unique identifier.

Additionally, the system control device 10 collects the path information necessary for the autonomous movable apparatus 12 to perform autonomous movement based on the position information that has been input to the user interface 11, and provides the path information using a unique identifier to the autonomous movable apparatus 12. Note that in the first embodiment, the system control device 10, the path determination device 13, and the conversion information holding device 14 function as, for example, servers.

In FIG. 4, the autonomous movable apparatus 12 is provided with a detection unit 12-1, the control unit 12-2, a direction control unit 12-3, an information storage unit (memory/HDD) 12-4, a network connection unit 12-5, and a drive unit 12-6.

The detection unit 12-1 has, for example, a plurality of imaging elements, and has a function of performing distance measurement based on a phase difference between a plurality of imaging signals obtained from the plurality of imaging elements. Additionally, the detection unit 12-1 has a self-position estimation function of acquiring detection information (hereinafter, referred to as “detection information”) such as a surrounding terrain and an obstacle such as a wall of a building, and estimating the one's own position based on the detection information and the map information.

Additionally, the detection unit 12-1 has a self-position detection function such as GPS (Global Positioning System) and a direction detection function such as a geomagnetic sensor. Furthermore, the control unit 12-2 can generate a three-dimensional map of the cyber space based on the acquired detection information, self-position estimation information, and direction detection information.

In this context, the three-dimensional map of the cyber space is capable of expressing spatial information equivalent to the feature position of the real world as digital data. In this three-dimensional map of the cyber space, the autonomous movable apparatus 12 that is present in the real world and the feature information of the vicinity thereof are held as spatially equivalent information as digital data. Therefore, efficient movement is possible by using this digital data.

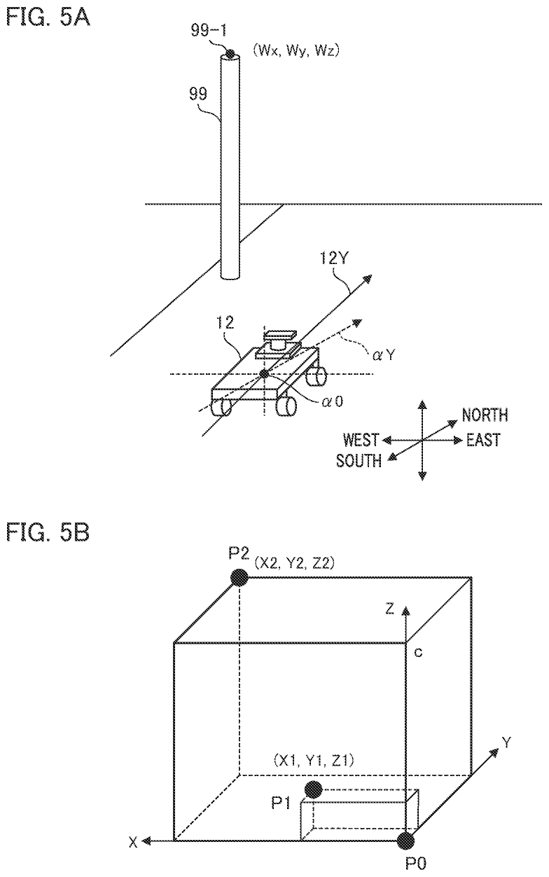

The three-dimensional map of cyberspace used in the first embodiment will be explained below with reference to FIG. 5 as an example. FIG. 5A is a diagram showing a spatial positional relation between the autonomous movable apparatus 12 and the column 99 that is present as feature information of the vicinity thereof in the real world, and FIG. 5B is a diagram showing a state in which the autonomous movable apparatus 12 and the pillar 99 are mapped on an arbitrary XYZ coordinate system space having P0 as an origin.

In FIGS. 5A and 5B, the position of the autonomous movable apparatus 12 is specified as the position α0 in the autonomous movable apparatus 12 based on the latitude and longitude position information acquired by a GPS (not illustrated) mounted on the autonomous movable apparatus 12. Additionally, the orientation and the moving speed of the autonomous movable apparatus 12 are specified by a difference between the azimuth αY acquired by an electronic compass and the like (not illustrated) and the moving direction 12Y of the autonomous movable apparatus 12.

Additionally, the position of the column 99 is specified as the position of the vertex 99-1 based on the position information measured in advance. Further, the distance from α0 of the autonomous movable apparatus 12 to the vertex 99-1 can be acquired by the ranging function of the autonomous movable apparatus 12. In FIG. 5A, coordinates (Wx, Wy, Wz) of the vertex 99-1 are shown in a case in which the moving direction 12Y is set as the axes of the XYZ-coordinate system and α0 is set as the origin.

In the three-dimensional map of the cyber space, the information acquired in this way is managed as digital data, and can be reconstructed as spatial information as shown in FIG. 5B by the system control device 10, the path determination device 13, and the like.

FIG. 5B shows a state in which the autonomous movable apparatus 12 and the column 99 are mapped to an arbitrary XYZ coordinate system space with P0 as an origin. By setting P0 to a predetermined latitude and longitude in the real world and taking the north of the real world in the Y-axis direction, the autonomous movable apparatus 12 can be expressed as P1 and the column 99 can be expressed as P2 in this arbitrary XYZ coordinate system space.

Specifically, the position P1 of α0 in this space can be calculated from the latitude and longitude of α0 and the latitude and longitude of P0. In addition, the column 99 can be calculated as P2. Although, in this example, the two of the autonomous movable apparatuses 12 and column 99 are expressed by the three-dimensional map of cyberspace, needless to say, a larger number of them can be handled in the same manner.

As described above, the three dimensional map is obtained by mapping the self-position of the real world and the object in the three dimensional space.

Returning to FIG. 4, the autonomous movable apparatus 12 stores the learning result data of the object detection in which the machine learning is performed in, for example, the information storage unit (memory/HDD) 12-4, and can perform the object detection from the captured image by using the machine learning.

Note that the detection information can also be acquired from an external system via the network connection unit 12-5 and reflected on the three-dimensional map. Note that the control unit 12-2 incorporates a CPU serving as a computer, controls the movement, direction change, and autonomous driving function of the autonomous movable apparatus 12, and controls the processing in each unit of the autonomous movable apparatus 12.

The direction control unit 12-3 changes the moving direction of the autonomous movable apparatus 12 by changing the driving direction of the movable apparatus by the drive unit 12-6. The drive unit 12-6 consists of a drive device, for example, a motor, and generates a propulsion force of the autonomous movable apparatus 12.

The autonomous movable apparatus 12 reflects the self-position and detection information, and object detection information in the three-dimensional map, generates a path that maintains a certain interval from the surrounding terrain, buildings, obstacles, and objects, and can perform autonomous driving.

Note that the path determination device 13 performs the route generation mainly in consideration of regulatory information related to the road traffic law. In contrast, the autonomous movable apparatus 12 more accurately detects the position of surrounding obstacles in the path performed by the path determination device 13, and performs the path generation for moving without touching obstacles based on its own size.

Additionally, the information storage unit (memory/HDD) 12-4 of the autonomous movable apparatus 12 can also store the mobility form of the autonomous mobile object itself. This mobility form is, for example, a type of a legally identified movable apparatus, and denotes a type, for example, of an automobile, a bicycle, and a drone. Based on this mobility form, the format path information to be described below can be generated.

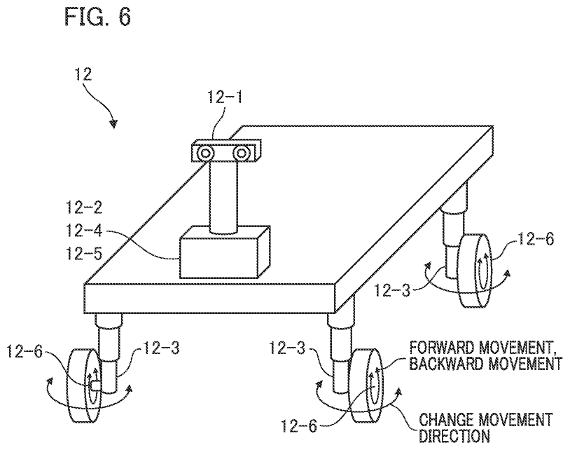

In this context, the body configuration of the autonomous movable apparatus 12 in the first embodiment will be explained with reference to FIG. 6. FIG. 6 is a perspective view showing an example of the mechanical configuration of the autonomous movable apparatus 12 according to the embodiment. Note that in the first embodiment, although the autonomous movable apparatus 12 will be explained as an example of a traveling object having wheels, the autonomous movable apparatus 12 is not limited thereto, and may be a flying object such as a drone.

In FIG. 6, the detection unit 12-1, the control unit 12-2, a direction control unit 12-3, the information storage unit (memory/HDD) 12-4, the network connection unit 12-5, and the drive unit 12-6 are mounted in the autonomous movable apparatus 12, and each unit is electrically connected to each other. At least two or more of the drive unit 12-6 and the direction control unit 12-3 are deployed on the autonomous movable apparatus 12.

The direction control unit 12-3 changes the moving direction of the autonomous movable apparatus 12 by changing the direction of the drive unit 12-6 by the rotational driving of the shaft, and the drive unit 12-6 moves the autonomous movable apparatus 12 forward and backward by the rotation of the shaft. Note that the configuration explained with reference to FIG. 6 is simply an example, and the present invention is not limited thereto, and for example, the moving direction may be changed by using an omni wheel and the like.

Note that the autonomous movable apparatus 12 is a autonomous movable apparatus using, for example, a simultaneous localization and mapping (SLAM) technology. Additionally, the autonomous movable apparatus 12 is configured to be able to autonomously move along a specified predetermined path based on detection information detected by the detection unit 12-1 and detection information of an external system acquired via the Internet 16.

The autonomous movable apparatus 12 can perform trace movement such that it traces a a point that has been specified in detail, or it can also generate path information and move by itself in the space between the points while passing a roughly set point.

Additionally, as described above, the autonomous movable apparatus 12 transmits information on the operation of one's own vehicle such as the direction, the moving speed, and the position information of one's own vehicle to the system control device 10 through the network connecting unit 12-5. Additionally, the system control device 10 transmits the information on the operation of the autonomous movable apparatus 12 that has been received from the autonomous movable apparatus 12 to the conversion information holding device 14 through the network connection unit 10-5.

The conversion information holding device 14 stores the information on the operation of the autonomous movable apparatus 12 such as the direction, the moving speed, and the position information of the autonomous movable apparatus 12, that has been received from the system control device 10, in the format database 14-4.

In the first embodiment, as in the case of the autonomous movable apparatus 12, information on the operation of each of the movable apparatuses other than the autonomous movable apparatus 12 such as the direction, the moving speed, and the position information of the movable apparatus is transmitted to the conversion information holding device 14.

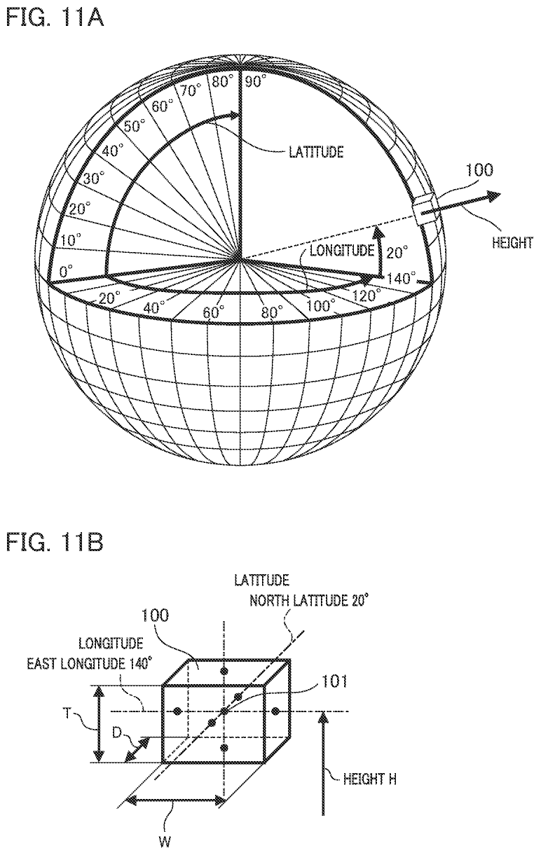

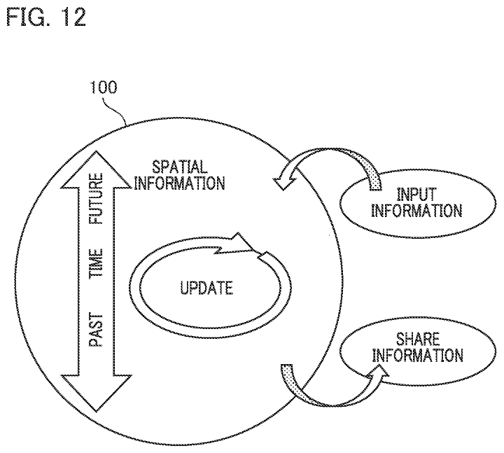

Accordingly, the direction, the moving speed, and the position information of the autonomous movable apparatus that is present in the space managed by the unique identifier are stored in the format database 14-4. How these pieces of information are stored will be explained below with reference to FIG. 11A, FIG. 11B, and FIG. 12. In the second embodiment to be described below, a control system pertaining to the reduction of blind spot accidents will be explained on the assumption that these pieces of information are stored.

As described above, the autonomous movable apparatus 12 of the first embodiment can autonomously move based on the path information using the unique identifier provided by the system control device 10.

Returning to FIG. 4, the sensor node 15 is an external system such as a video monitor system, for example, a road side camera unit, and is provided with a detection unit 15-1, the control unit 15-2, an information storage unit (memory/HDD) 15-3, and a network connecting unit 15-4. The detection unit 15-1 obtains detection information of an area that can be detected by the detection unit 15-1 itself, for example, a camera, and has an object detection function, a distance measurement function, an object recognition function, an imaging direction information, one's own-position information, and time at which an object was recognized.

The control unit 15-2 incorporates a CPU serving as a computer, controls the detection, data storage, and a data transmission function of the sensor node 15, and controls processing in each unit in the sensor node 15. Additionally, the detection information obtained by the detection unit 15-1 is stored in the information storage unit (memory/HDD) 15-3, and is transmitted to the conversion information holding device 14 through the network connection unit 15-4.

As described above, the sensor node 15 is configured to be capable of storing the detection information such as the image information detected by the detection unit 15-1, the feature point information of the detected object, and the position information in the information storage unit 15-3, and communicating the information. Additionally, the sensor node 15 provides the detection information of the area detectable by the sensor node 15 itself to the conversion information holding device 14.

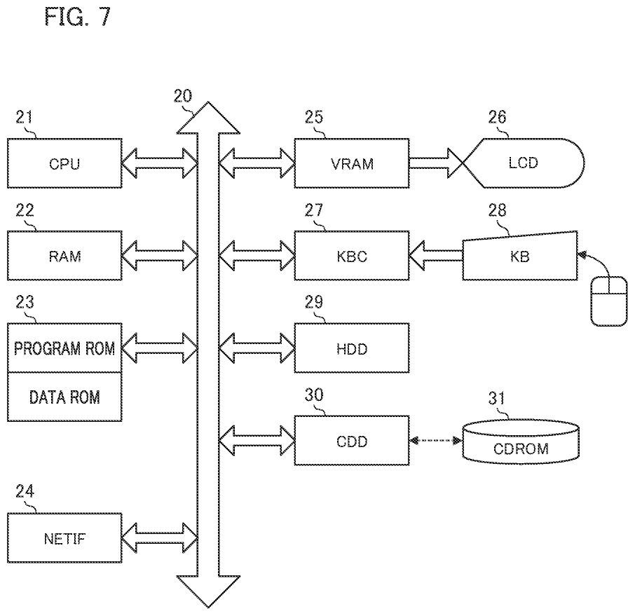

Next, a specific hardware configuration of each control unit in FIG. 4 will be explained. FIG. 7 is a block diagram illustrating an example of a specific hardware configuration of the control unit 10-2, the control unit 11-2, the control unit 12-2, the control unit 13-2, the control unit 14-2, and the control unit 15-2.

In FIG. 7, reference numeral 21 denotes a CPU serving as a computer that performs calculation and control of the information processing apparatus. Reference numeral 22 denotes a RAM that functions as a main memory of the CPU 21, a region for an execution program, an execution area for the program, and a data area. Reference numeral 23 denotes a ROM that stores the operation processing procedure of the CPU 21.

The ROM 23 is provided with a program ROM in which Operation System software (OS), which is a system program for performing device control of the information processing apparatus, is recorded, and a data ROM in which information necessary for operating the system is recorded.

Note that, an HDD 29 to be described below may be used, instead of the ROM 23. Reference numeral 24 denotes a network interface (NETIF) that performs control for data transfer between information processing apparatuses via the Internet 16 and assess of a connection state.

Reference numeral 25 denotes a video RAM (VRAM) 25 that develops an image to be displayed on a screen of the LCD 26, and controls the display. Reference numeral 26 denotes a display device such as a display (hereinafter, referred to as an “LCD”).

Reference numeral 27 denotes a controller (hereinafter, referred to as “KBC”) for controlling input signals from an external input device 28. Reference numeral 28 denotes an external input device (hereinafter, referred to as “KB”) for receiving operations performed by users, and for example, a keyboard, a pointing device including a mouse, and like are used.

Reference numeral 29 denotes a hard disk drive (hereinafter, referred to as “HDD”) that is used for storing application programs and various kinds of data. The application program in the first embodiment is a software program and the like that executes various types of processing functions in the first embodiment.

Reference numeral 30 denotes a CDD for inputting/outputting data to and from a removable output device 31 serving as a removable data recording medium such as a CD-ROM drive, a DVD drive, and a Blu-Ray (registered mark) disk drive. The CDD 30 is an example of an external input/output device. The CDD 30 is used in a case in which the above-described application program is read from a removable medium.

Reference numeral 31 denotes a removable medium including, for example, a CD-ROM disc, a DVD, and a Blu-Ray disc, which is read out by the CDD 30.

Note that the removable media may be magneto-optical recording media (for example, an MO), semi-conductor recording media (for example, a memory card), and the like. Note that the application program and data stored in the HDD 29 can be stored in the removable media 31 and used. Reference numeral 20 denotes a transmission bus (an address bus, a data bus, an input/output bus, and a control bus) for connecting each of the above-described units.

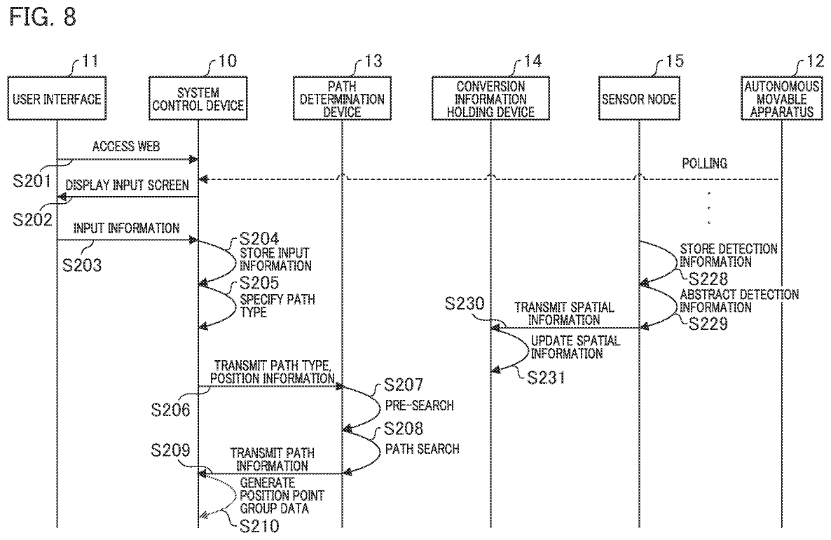

Next, details of the control operation in the autonomous movable apparatus control system for realizing the path setting application and the like as explained in FIG. 2 and FIG. 3 will be explained with reference to FIG. 8 to FIG. 10.

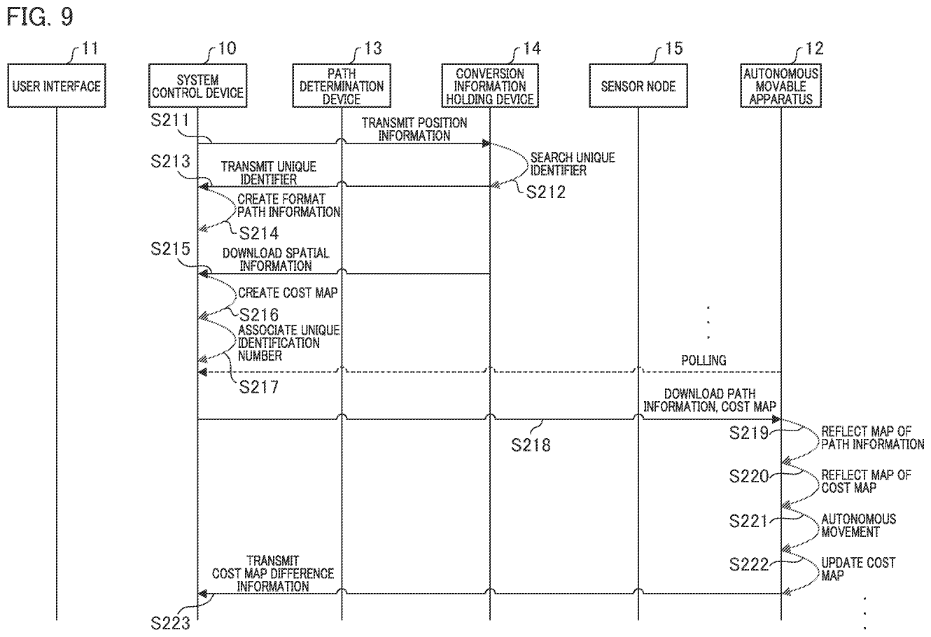

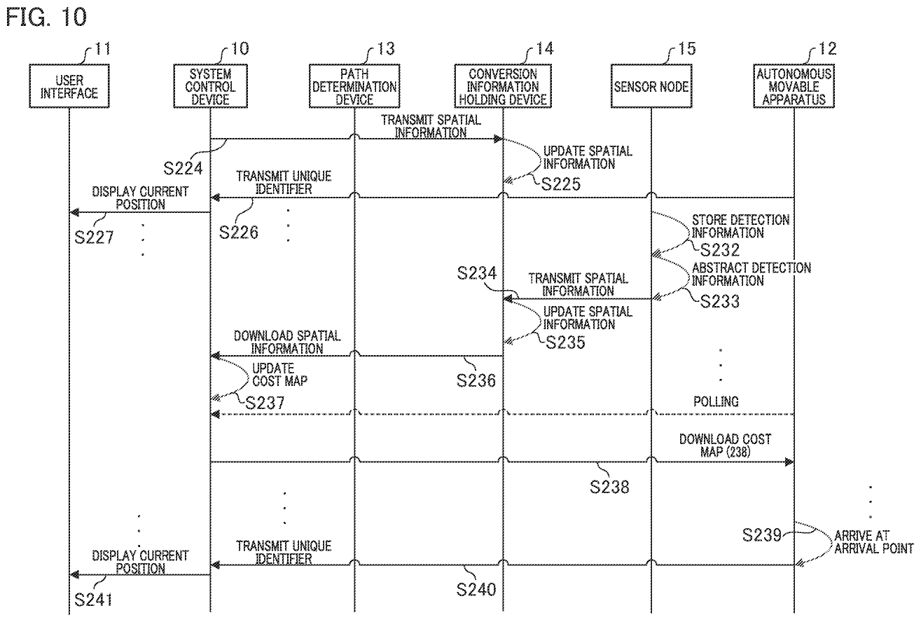

FIG. 8 is a sequence diagram that explains the processing executed by the autonomous movable apparatus control system according to the first embodiment, FIG. 9 is a sequence diagram continued from FIG. 8, and FIG. 10 is a sequence diagram continued from FIG. 9.

FIG. 8 to FIG. 10 illustrate processing executed by each device from when the user inputs the position information to the user interface 11 to when the current position information of the autonomous movable apparatus 12 is received. Note that the computer in the control unit in each device executes a computer program stored in the memory, and thereby the operation of each step in the sequence of FIG. 8 to FIG. 10 is performed.

First, in step S201, the user accesses a WEB page provided by the system control device 10 through the user interface 11. In step S202, the system control device 10 causes the display screen of the WEB page to display a position input screen as explained with reference to FIG. 2. In step S203, as explained with reference to FIG. 2, the user selects an autonomous movable apparatus (mobility) and inputs position information indicating departure/midway/arrival points (hereinafter, “position information”).

The position information may be a word that specifies a specific location such as a building name, a station name, and an address, (hereinafter, referred to as “position word”) or may be a method of specifying a specific position on a map displayed on the WEB page as a point (hereinafter, referred to as a “point”).

In step S204, the system control device 10 stores the type information of the selected autonomous movable apparatus 12 and the input position information. At this time, in a case in which the position information is the position word, the position word is stored, and in a case in which the position information is the point, the latitude/longitude corresponding to the point is searched based on the simple map information stored in the position/path information management unit 10-3, and the latitude/longitude is stored.

Next, in step S205, the system control device 10 specifies the type of a path along which the autonomous movable apparatus 12 can move (hereinafter, referred to as a path type) from the mobility form of the autonomous movable apparatus 12 specified by the user. Subsequently, in step S206, the system control device 10 transmits the path type to the path determination device 13 together with the position information.

The mobility form is a legally distinguished type of an autonomous movable apparatus, for example, an automobile, a bicycle, a drone, and the like. Additionally, the type of path in the case of automobiles is, for example, a general road, an expressway, a road dedicated to automobiles, and the like, and the type of path in the case of bicycles is a predetermined sidewalk, a side strip of a general road, a lane dedicated to bicycles, and the like.

In step S207, the path determination device 13 inputs the received position information as departure/midway/arrival points in the map information possessed by the path determination device 13. In the case in which the position information is the position word, the map information is searched using the position word, and corresponding latitude/longitude information is used. In the case in which the position information is the latitude/longitude information, the position information is directly input to the map information and used.

Subsequently, in step S208, the path determination device 13 searches for a path from the departure point to the arrival point via the midway point. At this time, the path determination device 13 searches for a path according to the path type. Then, in step S209, the path determination device 13 outputs a path from the departure point to the arrival point via the midway point (hereinafter, referred to as “path information”) in a GPX format (GPS-eXchange Format) as a result of the search, and transmits the path information to the system control device 10.

The file of the GPX format is mainly configured by three types of a midway point (point information having no order), a route (point information having an order to which time information is added), and a track (aggregate of a plurality of pieces of point information: tracks).

Latitudes/longitudes are described as attribute values of each piece of point information, and an altitude, a geoid height, a GPS reception status, accuracy, and the like are described as sub-elements. The minimum elements required for the GPX file are the latitude/longitude information of a single point, and the description of other information is arbitrary. What is output as the path information is the route, which is an aggregate of point information consisting a latitude/longitude having an order. Note that the path information may be in another format if the above is satisfied.

Here, a configuration example of the format managed by the format database 14-4 of the conversion information holding device 14 will be explained in detail with reference to FIG. 11A, FIG. 11B, and FIG. 12.

FIG. 11 a is a diagram showing latitude/longitude information of the earth, and FIG. 11B is a perspective view showing a predetermined space 100 in FIG. 11A. Additionally, in FIG. 11B, the center of the predetermined space 100 is defined as a center 101. FIG. 12 is a diagram schematically showing spatial information in the space 100.

In FIG. 11A and FIG. 11B, the format can be managed by dividing the space of the earth into three dimensional spaces determined by a range with latitude, longitude, and height as a start point and adding a unique identifier to each space.

For example, here, the space 100 is displayed as a predetermined three dimensional space. The space 100 is a divided space that is defined to have a north latitude of 20 degrees, an east longitude of 140 degrees, and a height of H as the center 101, a width in a latitude direction of D, a width in a longitude direction of W, and a width in a height direction of T. Additionally, the space 100 is one space obtained by dividing the space of the earth into spaces determined by a range with the latitude, longitude, and height as a start point.

Although only the space 100 is shown in FIG. 11A for convenience, it is assumed that spaces defined in the same manner as the space 100 are arranged side by side in the latitude, longitude, and height directions as described above in the definition of the format.

It is assumed that each of the horizontal positions of the arranged divided spaces is defined by each of latitudes/longitudes, the arranged divided spaces overlap each other in the height direction, and the positions in the height direction are defined depending on the heights.

Note that although, in FIG. 11B, the center 101 of the divided space is set as the start point of the latitude, longitude, and height, the start point is not limited thereto, and for example, a corner of the space or the center of the bottom surface may be set as the start point.

Additionally, the shape may be a almost rectangular parallelepiped, and when considering the case of being laid on the surface of a sphere such as the earth, it is better to set the top surface of the rectangular parallelepiped to be slightly wider than the bottom surface thereof, so that the space can be arranged without a gap.

In FIG. 12, taking the space 100 as an example, in the format database 14-4, each piece of information on the type and time of an object that can be present in or enter the range of the space 100 (spatial information) is stored by being formatted in association with a unique identifier, and the information is stored. Additionally, formatted spatial information is stored in chronological order, from the past to the future.

That is, the conversion information holding device 14 formats the spatial information on the type of the object that can present in or enter the three dimensional space defined by latitude, longitude, and height in association with the unique identifier, and stores the formatted spatial information in the format database 14-4.

The spatial information is updated based on the information input by an external system (for example, the sensor node 15) and the like that are communicably connected to the conversion information holding device 14, and the information is shared with another external system that is communicably connected to the conversion information holding device 14.

Note that, as described above about the autonomous movable apparatus 12, the autonomous movable apparatus 12 transmits information on the operation of one's own vehicle including the direction and the moving speed and position information of the own vehicle, and how these pieces of information are stored will be explained here.

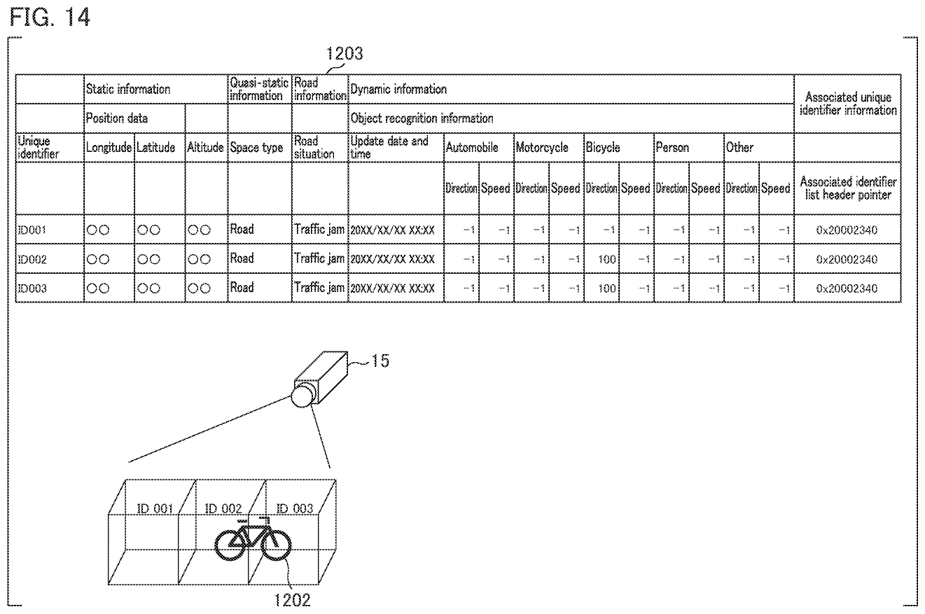

FIG. 14 is a diagram that explains how data is stored in the format database 14-4. FIG. 14A is a diagram showing a table illustrating an example of information stored in association with a unique identifier. FIG. 14B is a schematic perspective view illustrating an example of a state in which the sensor node 15 captures images of spaces.

The sensor node 15 is arranged so that images of spaces to which a unique identifier 001 (hereinafter also referred to as “ID001”), a unique identifier 002 (hereinafter also referred to as “ID002”), and a unique identifier 003 (hereinafter also referred to as “ID003”) are allocated can be captured.

The sensor node 15 recognizes that the bicycle 1202 is a bicycle. Additionally, the sensor node 15 recognizes how far the bicycle 1202 is located from the sensor node 15, that is, the distance from the sensor node 15 to the bicycle 1202, by the distance measuring function.

Furthermore, since the sensor node 15 also has the self-position information and the image capture direction information, it is possible to grasp that the bicycle 1202 is present in the space to which ID002 and ID003 are allocated by performing the calculation together with the distances.

Since the sensor node 15 performs the object recognition processing for each captured frame, it is possible to calculate the direction and moving speed of the autonomous movable apparatus in the captured image from the difference in position from the previous frame. Table 1203 is a table in which information recognized by the sensor node 15 is summarized.

In the present control system, as shown in Table 1203, items of an automobile, a motorcycle, a bicycle, and a person are prepared as recognition objects for each unique identifier. If the object is not present in the space where the unique identifier is allocated, −1 is input.

In a case in which the object is present in the space to which the unique identifier is allocated, the direction and the speed of the object are input. In Table 1203, the direction is represented by an angle in which the north is set to 0 degrees and one round is set to 360 degrees counterclockwise.

In Table 1203, the speed is represented by a speed per second [m/s]. The sensor node 15 performs the object recognition for each captured frame, collects data as in Table 1203, and transmits the data to the conversion information holding device 14 via the network connecting unit 15-4.

Note that the sensor node 15 may only perform the object recognition as to which object is present at which position, and transmit the object recognition result to the conversion information holding device 14 via the network connecting unit 15-4. In this case, the conversion information holding device 14 may store the received object recognition result in the unique identifier managing unit 14-2 in the form of Table 1203 in accordance with the format database 14-4.

As described above, in the first embodiment, information on the type and time of an object that can be present in or enter a three dimensional space defined by latitude, longitude, and height (hereinafter, referred to as “spatial information”) is formatted in association with a unique identifier and stored in the database. Subsequently, the formatted spatial information enables management of the time and space.

Returning to FIG. 8, the continuation of the processing executed by the autonomous movable apparatus control system will be explained again. In step S210, the system control device 10 confirms the interval between each point information in the received path information.

Then, the interval of the point information and the interval between the start point positions of the divided spaces defined by the format are matched to create position point group data (hereinafter, referred to as “position point group data”).

At this time, in a case in which the interval of the point information is smaller than the interval of the start points of the divided spaces, the system control device 10 sets the position point data obtained by thinning out the point information in the path information in accordance with the interval of the start position of the divided space as the position point group data. Additionally, in a case in which the interval of the point information is larger than the interval of the start points of the divided spaces, the system control device 10 sets position point group data by interpolating the point information within a range not to deviate from the path information.

Next, as shown in step S211 of FIG. 9, the system control device 10 transmits the latitude/longitude information of each point information of the position point group data to the conversion information holding device 14 in the order of the path. Additionally, in step S212, the conversion information holding device 14 searches for the unique identifier corresponding to the received latitude/longitude information from the format database 14-4, and in step S213, transmits the unique identifier to the system control device 10.

In step S214, the system control device 10 arranges the received unique identifiers in the same order as the original position point group, and stores them as path information using the unique identifiers (hereinafter, referred to as “format path information”). Thus, in step S214, the system control device 10 acquires the spatial information from the database of the conversion information holding device 14, and generates the path information regarding the moving path of the autonomous movable apparatus based on the acquired spatial information and the type information of the autonomous movable apparatus.

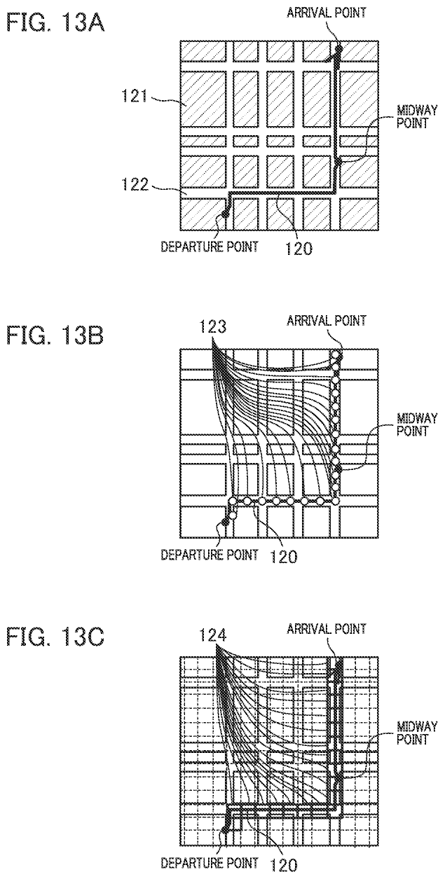

Here, a process of generating the position point group data from the path information and converting the position point group data into the path information using the unique identifier will be explained in detail with reference to FIG. 13A, FIG. 13B, and FIG. 13C. FIG. 13A is an image diagram in which the path information is displayed as map information, FIG. 13B is an image diagram in which the path information using the position point group data is displayed as map information, and FIG. 13C is an image diagram in which the path information using the unique identifier is displayed as map information.

In FIG. 13A, reference numeral 120 denotes path information, reference numeral 121 denotes a non-movable region through which the autonomous movable apparatus 12 cannot pass, and reference numeral 122 denotes a movable region through which the autonomous movable apparatus 12 can move. The path information 120 generated by the path determination device 13 based on the position information of the departure point, the midway point, and the arrival point specified by the user is generated as a path passing through the departure point, the midway point, and the arrival point and passing through the movable region 122 based on the map information.

In FIG. 13B, reference numeral 123 denotes a plurality of pieces of position information on the path information. The system control device 10 that has acquired the path information 120 generates the position information 123 arranged at predetermined intervals on the path information 120.

The position information 123 can be represented by latitudes/longitudes/heights, and the position information 123 is referred to as position point group data in the first embodiment. Then, the system control device 10 transmits the latitudes/longitudes/heights of the points of the position information 123 to the conversion information holding device 14 one by one, and converts them into unique identifiers.

In FIG. 13C, reference numeral 124 denotes position spatial information in which the position information 123 is converted into unique identifiers one by one, and a space range defined by the unique identifiers is represented by a rectangular frame. The positional spatial information 124 can be acquired by converting the position information into unique identifiers.

As a result, the path represented by the path information 120 is converted into the continuous position spatial information 124 and represented. Note that the each of the position spatial information 124 is associated with the information on the type and time of an object that can be present in or enter the range of the space. In the first embodiment, this continuous position spatial information 124 is referred to as format path information.

Returning to FIG. 9, the continuation of the processing executed by the autonomous movable apparatus control system will be explained again. After step S214, in step S215, the system control device 10 downloads the spatial information associated with each unique identifier of the format path information from the conversion information holding device 14.

Then, in step S216, the system control device 10 converts the spatial information into a format that can be reflected in the three dimensional map of the cyberspace of the autonomous movable apparatus 12, and creates information indicating the positions of a plurality of objects (obstacles) in a predetermined space (hereinafter, referred to as a “cost map”). The cost map may be created first for the spaces of all the paths of the format path information or may be created in a form divided by a certain region and sequentially updated.

Next, in step S217, the system control device 10 stores the format path information and the cost map in association with a unique identification number assigned to the autonomous movable apparatus 12. The autonomous movable apparatus 12 monitors its own unique identification number via a network at predetermined time intervals (hereinafter, referred to as “polling”), and, in step S218, downloads the associated cost map.

In step S219, the autonomous movable apparatus 12 reflects the latitude/longitude information of each unique identifier of the format path information on the cyberspace three dimensional map created by the autonomous movable apparatus 12 as path information.

Next, in step S220, the autonomous movable apparatus 12 reflects the cost map on the cyberspace three dimensional map as obstacle information on the route. In a case in which the cost map is created in a form that is divided at regular intervals, the cost map of the next region is downloaded, and the cost map is updated after the region where the cost map is created is moved.

In step S221, the autonomous movable apparatus 12 moves along the path information while avoiding an object (obstacle) input in the cost map. That is, movement control is performed based on the cost map. In this case, in step S222, the autonomous movable apparatus 12 moves while performing object detection, and if there is a difference from the cost map, the autonomous movable apparatus 12 moves while updating the cost map by using object detection information.

Additionally, in step S223, the autonomous movable apparatus 12 transmits the difference information from the cost map to the system control device 10 together with the corresponding unique identifier. In step S224 of FIG. 10, the system control device 10 that has acquired the difference information between the unique identifier and the cost map transmits the spatial information to the conversion information holding device 14, and, in step S225, the conversion information holding device 14 updates the spatial information of the corresponding unique identifier.

The content of the spatial information updated here does not reflect the difference information from the cost map as it is, and is abstracted by the system control device 10 and then transmitted to the conversion information holding device 14. The detailed contents of the abstraction will be described below.

In step S226, the autonomous movable apparatus 12 moving based on the format path information transmits the unique identifier associated with the space through which the autonomous moving object 12 itself is currently passing to the system control device 10 every time the autonomous moving object 12 passes through the divided space associated with each unique identifier.

Alternatively, at the time of polling, association with its own unique identification number may be performed. The system control device 10 grasps the current position of the autonomous movable apparatus 12 on the format path information based on the unique identifier information of the space received from the autonomous movable apparatus 12.

By repeating step S226, the system control device 10 can grasp where the autonomous movable apparatus 12 is currently located in the format path information. Note that the system control device 10 may stop holding the unique identifier of the space through which the autonomous movable apparatus 12 has passed, and thereby the held data capacity of the format path information can be reduced.

In step S227, the system control device 10 creates the confirmation screen 50 and the map display screen 60 explained with reference to FIG. 2 and FIG. 3 based on the grasped current position information of the autonomous movable apparatus 12, and displays the confirmation screen 50 and the map display screen 60 on the display screen of the WEB page. Each time the unique identifier indicating the current position is transmitted to the system control device 10 by the autonomous movable apparatus 12, the system control device 10 updates the confirmation screen 50 and the map display screen 60.

In contrast, in step S228, the sensor node 15 stores the detection information of the detection range, and in step S229, the sensor node 15 abstracts the detection information, and, in step S230, the sensor node 15 transmits the abstracted detection information to the conversion information holding device 14 as spatial information.

The abstraction is, for example, information indicating whether or not an object is present and whether or not the presence state of the object has changed, and is not detailed information on the object.

The detailed information on the object is stored in the memory in the sensor node. Then, in step S231, the conversion information holding device 14 stores the spatial information, which is the abstracted detection information, in association with the unique identifier of the position corresponding to the spatial information. As a result, the spatial information is stored in one unique identifier in the format database.

Additionally, in a case in which an external system that is different from the sensor node 15 utilizes the spatial information, the external system acquires and utilizes the detection information in the sensor node 15 via the conversion information holding device 14 based on the spatial information in the conversion information holding device 14. At this time, the conversion information holding device 14 also has a function of connecting the communication standard of the external system and the sensor node 15.

By storing the spatial information as described above between a plurality of devices, in addition to the sensor node 15, the conversion information holding device 14 has a function of connecting data of a plurality of devices with a relatively light data amount. Note that in a case in which, in steps S215 and S216, the system control device 10 needs detailed object information when a cost map is created, the detailed information may be downloaded from an external system that stores detailed detection information of the spatial information and used.

Here, it is assumed that the sensor node 15 updates the spatial information on the path of the format path information of the autonomous movable apparatus 12. At this time, in step S232, the sensor node 15 acquires the detection information, in step S233, generates abstracted spatial information, and, in step S234, transmits the abstracted spatial information to the conversion information holding device 14. In step S235, the conversion information holding device 14 stores the spatial information in the format database 14-4.

The system control device 10 confirms a change in the spatial information in the format path information to be managed at predetermined time intervals, and if there is a change, the spatial information is downloaded in step S236.

Then, in step S237, the cost map associated with the unique identification number assigned to the autonomous movable apparatus 12 is updated. In step S238, the autonomous movable apparatus 12 recognizes the update of the cost map by polling, and reflects the update on the cyberspace three-dimensional map created by the autonomous movable apparatus 12.

As described above, by utilizing spatial information shared by a plurality of devices, the autonomous movable apparatus 12 can recognize a change in advance on the route that cannot be recognized by the autonomous movable apparatus 12, and can cope with the change.

In a case in which the autonomous movable apparatus 12 arrives at the arrival point in step S239 by executing the series of systems, the unique identifier is transmitted in step S240.

Thereby, in step S241, the system control device 10 that has recognized the unique identifier displays an arrival display on the user interface 11, and ends the application.

According to the first embodiment, as described above, it is possible to provide a digital architecture format and an autonomous movable apparatus control system using the same.

As explained with reference to FIG. 11A, FIG. 11B, and FIG. 12, in the format database 14-4, information on the type and time of an object that can be present in or enter the range of the space 100 (spatial information) is stored in time series from the past to the future.

Additionally, the spatial information is updated based on the information that has been input from an external sensor and the like that are communicably connected to the conversion information holding device 14, and is shared by another external system that can be connected to the conversion information holding device 14.

As one of the spatial information, there is type information of an object in the space. The type information of the object in the space is information that can be acquired from map information, for example, a roadway, a sidewalk, a bicycle road, and the like in a road. In addition, information such as a traveling direction of a mobility and traffic regulations in the roadway can be similarly defined as the type information. Furthermore, the type information can be defined in the space itself.

### Second Embodiment

In the second embodiment, a control system pertaining to reduction of a blind spot accident using the autonomous movable apparatus control system of the first embodiment will be explained. The control of the present system is realized by, for example, the conversion information holding device 14 as shown in FIG. 4 executing main control. Hereinafter, this system is referred to as a blind spot accident reduction system.

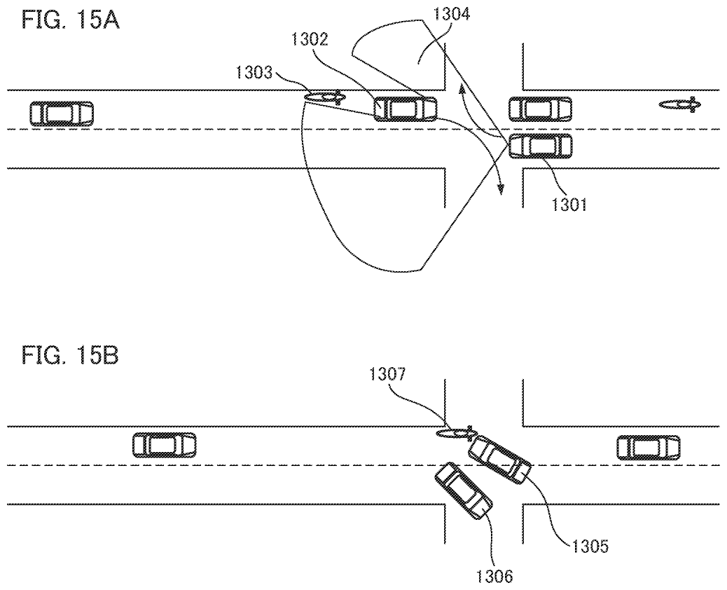

FIG. 15A and FIG. 15B are diagrams that explain a blind spot accident. The blind spot accident refers to an accident in which a collision factor, such as a motorcycle, a bicycle, and a person, unexpectedly enters and collides with the traveling path of the own vehicle from a blind spot that cannot be recognized by a driver of an automobile or an in-vehicle camera.

There are various patterns of blind spot accidents, and the pattern of FIG. 15A and FIG. 15B that is a typical blind spot accident will be explained as an example in the second embodiment. Although, in the second embodiment, an intersection is explained as an example of a collision risk area that is an area in which the autonomous movable apparatus 12 may collide with a collision factor to be described below, an area other than the intersection may be set as the collision risk area.

FIG. 15A shows a state before an accident occurs, and FIG. 15B shows a state in which an accident has occurred. FIG. 15A shows a state in which an own vehicle 1301 waiting for a right turn at an intersection starts to turn right at a timing when an oncoming vehicle 1302 turns right.

A front in-vehicle camera is mounted on the own vehicle 1301, and its field of view is represented by a field of view 1304. At the time point of FIG. 15A, a motorcycle 1303 is hidden in the blind spot of the oncoming vehicle 1302, and is not captured by the front in-vehicle camera of the own vehicle 1301.

Then, in FIG. 15B, the own vehicle 1301 travels and becomes an own vehicle 1305, and the oncoming vehicle 1302 travels and becomes an oncoming vehicle 1306. In FIG. 15B, when the own vehicle 1305 tries to turn right, a motorcycle 1307 suddenly appears from behind the oncoming vehicle 1306, detection is delayed, and the motorcycle collides with the own vehicle 1305.

In order to reduce the accident as shown in FIG. 15A and FIG. 15B, the blind spot accident reduction system of the second embodiment detects the collision factor that is rushing out to the road from the blind spot that cannot be detected by the driver or the in-vehicle camera by using the information of the above-described autonomous movable apparatus control system.

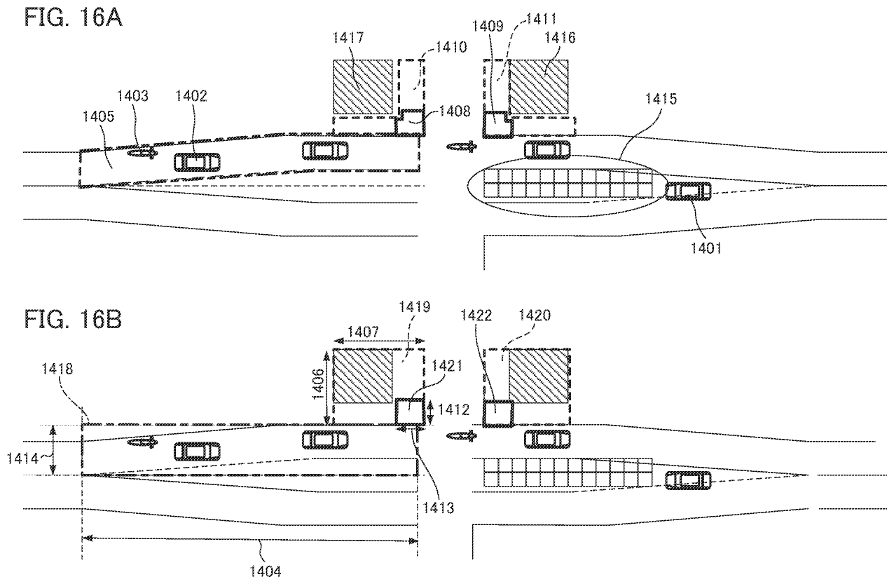

In order to reduce the accident as shown in FIG. 15A and FIG. 15B, the blind spot accident reduction system of the second embodiment prevents the collision in advance by performing the following items (1) to (4).
(1) A search range (map coordinates) of a unique identifier in which a collision factor is likely to be present is specified.
(2) A unique identifier list is created from the specified search range (map coordinates), and stored.
(3) It is determined whether or not a collision factor is present based on the created unique identifier list, and the collision factor is stored in the unique identifier of the right turn lane.
(4) The right-turn vehicle acquires information on the collision factor from the unique identifier in the right-turn lane, and determines the timing of the right turn. Details of the items (1) to (4) will be described below.
   (1) A search range (map coordinates) of a unique identifier in which a collision factor is likely to be present is specified. FIG. 16A and FIG. 16B are top views of the intersection. FIG. 16A is a diagram that explains a search range of a collision factor in the blind spot accident reduction system of the second embodiment.

The intersection shown in FIG. 16A is selected from a plurality of intersections by acquiring road information from road network data (not illustrated) on the Internet. Here, the road network data is road information created from digital road map data, and is information created by the Road Map Association and the like.

In the method of selecting an intersection in the second embodiment, a place where an accident is likely to occur is determined based on the number of lanes, the road width, and the like that have been acquired from the road information, and the intersections are sequentially selected. Since it takes time to select and process all intersections, the number of intersections to be selected is limited according to the processing capacity of the conversion information holding device 14.

The conversion information holding device 14 acquires the map information and the intersection coordinates of the selected intersection, and the maximum speed of the road. FIG. 16A illustrates a state in which a right-turn vehicle 1401 traveling from right to left in the drawing is about to enter the right-turn lane in order to turn right upward in the drawing at the intersection. The right-turn vehicle 1401 is the autonomous movable apparatus 12 in FIG. 4.

In FIG. 16A, an area 1405, an area 1410, an area 1411, an area 1408, and an area 1409 are each set. These areas indicate areas in which there is the highest possibility that a motorcycle, a bicycle, or a person who may enter the traveling path of the right-turn vehicle 1401 is present when the right-turn vehicle 1401 turns right at the intersection several seconds after the state of FIG. 16A.

Although the conversion information holding device 14 is intended to automatically detect a collision factor from these areas, in this item (1), a rectangle including these areas is automatically set.

An example of a rectangle automatically set is shown in FIG. 16B. A rectangle 1418 includes the area 1405, a rectangle 1419 includes the area 1410, a rectangle 1420 includes the area 1411, a rectangle 1421 includes the area 1408, and a rectangle 1422 includes the area 1409.

First, a method of setting a rectangle 1418 will be explained. The rectangle 1418 is a region surrounded by a dashed-dotted line, and is an area for mainly detecting a motorcycle. A motorcycle that may collide with the right-turn vehicle 1401 is currently present only on the left side of the intersection of the oncoming lane. Thus, the end on the right side of the rectangle 1418 is the intersection. Since the motorcycle travels on the road, the vertical width of the rectangle 1418 is the road width of the oncoming lane.

The left end of the rectangle 1418 is as follows. Since the right-turn vehicle 1401 is still in front of the intersection, the motorcycle that may collide with the right-turn vehicle 1401 is also traveling in front of the intersection.

In FIG. 16B, if the right-turn vehicle 1401 is at the position Tm seconds to the intersection, the motorcycle that may collide with the right-turn vehicle 1401 is also at the position Tm seconds to the intersection. However, since the speed of the bike is not known at the current point, the speed of the bike is assumed to be 0 to twice the maximum speed of the road on which the bike is traveling.

Here, the speed is set to be double the maximum speed so that a motorcycle traveling without maintaining the maximum speed is also detected, and the double is a safety coefficient thereof, and the safety coefficient may be set to be, for example, 1.5 times or 3 times depending on the situation.

In this case, a distance A, which is a distance from the intersection to a position farthest from the intersection among positions at which the motorcycle having a possibility of colliding with the right-turn vehicle 1401 can be present at the current time, is expressed by Formula 1 below.

Distance A=Tm [s]×maximum speed of traveling road [m/s]×2 (Formula 1)

The motorcycle that may collide with the right-turn vehicle 1401 is estimated to be somewhere between the intersection and the distance A. Thus, the left end of the rectangle 1418 in a case in which only the speed of the right-turn vehicle 1401 is considered is the distance A.

Furthermore, in order to detect a motorcycle having a possibility of colliding with the right-turn vehicle 1401 based on the data of the format database 14-4, it is necessary to consider the update delay of this database. Here, the update delay of the format database 14-4 will be explained.

Processing is necessary in which the sensor node captures an image of the motorcycle, recognizes the motorcycle by object recognition, and generates data and store it in the format database 14-4 so that the information on the presence of the motorcycle is introduced into the format database 14-4. Therefore, the information stored in the format database 14-4 is older than the information at the current time.

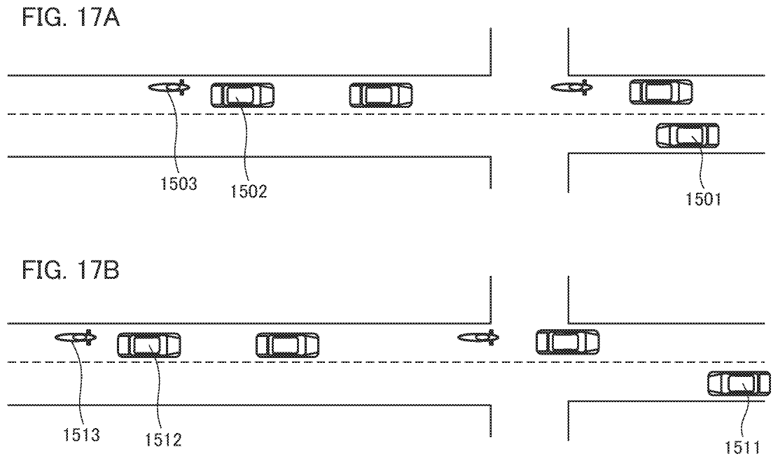

FIG. 17A and FIG. 17B are diagrams when the information being currently held by the format database 14-4 is mapped. FIG. 17A illustrates a state of the current real world. The positional relation between the right-turn vehicle 1501, the oncoming vehicle 1502, and the motorcycle 1503 is as shown in FIG. 17A.

At this time, the data stored in the format database 14-4 is information before the time difference Ts seconds obtained by subtracting the update time from the current time as shown in FIG. 17B. The right-turn vehicle 1501 is stored in the format database 14-4 as a right-turn vehicle 1511.

The oncoming vehicle 1502 is stored in the format database 14-4 as the oncoming vehicle 1512. The motorcycle 1503 is stored in the format database 14-4 as the motorcycle 1513.

In the second embodiment, this Ts second is set to 1 second. Therefore, in the format database 14-4, the right-turn vehicle 1511, the oncoming vehicle 1512, and the motorcycle 1513 are respectively stored at positions one second before the current state of FIG. 17A. Therefore, when the update delay of the database is taken into consideration, the left end of the rectangle 1418 is further to the left by a distance B from the above-described distance A. The distance B is expressed by Formula 2 below.

Distance B=Ts [s]×maximum speed of traveling road [m/s]×2 (Formula 2)

It is estimated that the motorcycle that may collide with the right-turn vehicle 1401 is somewhere between the intersection and (distance A+distance B). Thus, the left end of the rectangle 1418 in the case of taking into consideration the speed of the right-turn vehicle 1401 and the update delay of the database is (distance A+distance B). In the second embodiment, the distance from the right end to the left end of the rectangle 1418 is set as the length 1404.

In practice, one example of the length 1404 will be obtained. The maximum speed of the traveling road is obtained by converting 30 km/h or 40 km/h determined for each road into a speed per second. That is, 30 km/h is about 8.3 m/s, and 40 km/h is about 11.1 m/s.

In this context, it is assumed that the right-turn vehicle 1401 is located at a position three seconds before the intersection. Additionally, it is assumed that update delay of the database is one second. Additionally, it is assumed that the safety coefficient is set to double. Additionally, it is assumed that the maximum speed of the traveling road is 40 km/h. At this time, the length 1404 is obtained by Formula 3 below.

Length 1404=3 [s]×11.1 [m/s]×2+1 [s]×11.1 [m/s]×2=88.8 m (Formula 3)

Thus, the length 1404 is 88.8 m, and the rectangle 1418 is set to a portion of 88.8 m from the intersection to the left along the road in the drawing.

By setting the left end of the rectangle 1418 to the above-described value, it is possible to pick up almost all motorcycles that may be currently present at the intersection. As for the coordinates of the rectangle 1418, the start point coordinates at the upper right of the rectangle and the end point coordinates at the lower left of the rectangle can be obtained based on the intersection coordinates of the road network data.

Although, at this point in time, the rectangle 1418 has a shape including areas/items other than the road, in the next item (2), a method of picking up only the unique identifier that is present on the road of area 1405 will be explained.

Next, a method of setting areas of a rectangle 1419 including the area 1410 and a rectangle 1420 including the area 1411 will be explained. The area 1410 and the area 1411 are areas for detecting a bicycle. In FIG. 16, reference numerals 1416 and 1417 denote buildings.

An area 1410 indicates a range in which a bicycle coming from the upper side of FIG. 16 and a bicycle coming from the left side of FIG. 16, which are traveling toward the intersection through the sidewalk, are present. In contrast, an area 1411 indicates a range in which a bicycle coming from the upper side of FIG. 16 and a bicycle coming from the right side of FIG. 16, which are traveling toward the intersection through the sidewalk, are present.

Although there is a case in which it is legally prohibited for a bicycle to pass through a sidewalk, a bicycle in violation can also be detected from the viewpoint of accident prevention. Here, it is assumed that the maximum speed of bicycles is about 40 km/h, and as in the case of motorcycles described above, the distance C, which is the distance from the intersection of the end at the distant side from the intersection of the rectangle that picks up the presence of a vehicle, is calculated by the following formula 4.

Distance C=3 [s]×11.1 [m/s]+1 [s]×11.1 [m/s]=44.4 m (Formula 4)

In the case of bicycles, twice the safety coefficient is not used. In the second embodiment, each of the length 1407 and the length 1406 is set to the distance C. That is, each of the length 1407 and the length 1406 is 44.4 m. By setting this length to the distance C, it is possible to pick up almost all of the bicycles that may be present at the intersection at present.

As for the area coordinates of the rectangle 1419 and the rectangle 1420, the start point coordinates at the upper right and the ending point coordinates at the lower left can be obtained based on the intersection coordinates of the road network data. Although, at this point in time, the rectangle 1419 has a shape including the area 1410 and the rectangle 1420 has a shape including the area 1411, in the next item (2), a method of picking up only the unique identifiers that are present in the area 1410 and the area 1411 will be explained.

Next, similar to the bicycle, a method of setting a rectangle 1421 including the area 1408 and a rectangle 1422 including the area 1409 will be explained. The area 1408 and the area 1409 are areas in which a person is detected.

It is assumed that a person runs 100 m in about 10 seconds, and, in the second embodiment, each of the length 1412 and the length 1413 is set to about 10 m. By setting the length 1412 and the length 1413 to this value, it is possible to pick up almost all pedestrians who may be currently present at the intersection.

As for the area coordinates of the rectangle 1421 and the rectangle 1422, the start point coordinates at the upper right and the end point coordinates at the lower left can be obtained based on the intersection coordinates of the road network data. At this time, the rectangle 1421 has a shape including the area 1408 and the rectangle 1422 has a shape including the area 1409, and in the next item (2), a method of picking up only the unique identifiers that are present in the area 1408 and the area 1409 will be explained.

The start point coordinates and the end point coordinates obtained as described above are stored in an associated unique identifier list header to be described in the next item (2). In the second embodiment, the range is automatically described, but in a case in which the shape of the intersection is complicated, it is also considered that the range is manually input.

(2) A unique identifier list is created from the specified search range (map coordinates) and stored. In this item (2), a method of picking up unique identifiers that are present in the effective area from the rectangle set in the item (1) and creating and storing a unique identifier list will be explained.

The coordinates of the rectangle including the area 1405, the area 1408, the area 1409, the area 1410, and the area 1411 are obtained in the above item (1). Here, by confirming the information on each unique identifier in this rectangle, it is determined whether or not the confirmed unique identifier is in each area.

First, the case of the area 1405 will be explained. As shown in Table 1203 of FIG. 14, the space type information of the semi-static information is recorded in the unique identifier. In the case of the area 1405, it is confirmed whether or not the space type information of the unique identifier is a road.

When the space type information is a road, it is determined that the unique identifier is in the area 1405, and this unique identifier is added to the unique identifier list. When the search of all the unique identifiers in the rectangle 1418 ends, the unique identifier list is complete.

Similarly, in the case of the area 1410, the area 1411, the area 1408, and the area 1409, the unique identifier list is created by confirming that the space type information of the unique identifier is a sidewalk.

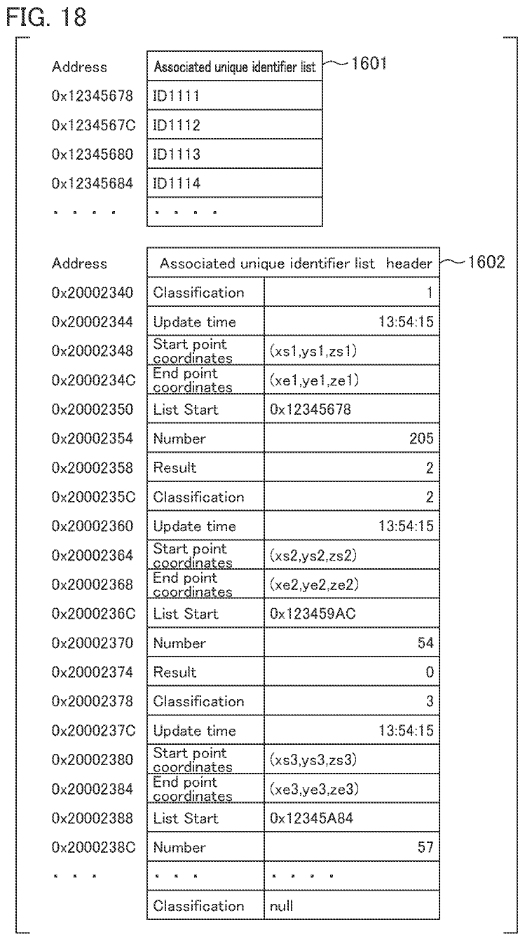

FIG. 18 is an explanatory view of a format that stores completed data. The unique identifier list created as described above is stored in the information storage unit 14-5 as an associated unique identifier list as shown in Table 1601.

In order to facilitate retrieval of each piece of data from the associated unique identifier list of Table 1601, the associated unique identifier list header of Table 1602 is also created. Table 1602 is metadata of the associated unique identifier list of Table 1601.

In the associated unique identifier list header, the information on the area is managed by structure, and the structure is stored in the form of a list. The elements of the structure include classifications, update times, start coordinates, end coordinates, list start pointers, the number, and results.

The classification among the elements of the structure is a number that is assigned to each area. In the second embodiment, since there are five associated areas (the area 1405, the area 1410, the area 1411, the area 1408, and the area 1409), the classifications 1 to 5 respectively correspond to the five areas. In the example of Table 1602, the classification 1, that is, the header information of the area 1405 is described.

In the update time among the elements of the structure, the time when the result to be described below is updated is stored. In the list start pointer among the elements of the structure, the head address of the unique identifier list of the area corresponding to the classification is stored.

The number of elements of the structure is the number of unique identifiers described in the unique identifier list. The result of reading the unique identifier list is described in the result of the elements of the structure. The contents of this result will be described below.

Next, the association of the created associated unique identifier list header with the unique identifier of the right turn lane is performed. As explained in Table 1203 of FIG. 14, the information on the unique identifier includes the item of the associated unique identifier information, and the head address information of the associated unique identifier list header can be registered in this item.

For example, the head address of the associated unique identifier list header in Table 1602 is stored in the associated unique identifier information of the unique identifier corresponding to the area 1415 of the right turn lane in FIG. 16. As a result, the area 1405, the area 1410, the area 1411, the area 1408, and the area 1409 can be associated with the unique identifier indicating the area 1415.

In this case, since the information on Table 1601 generated in the items (1) and (2) is not information that changes in a short period of time, the information may be changed only when road construction occurs. Therefore, the confirmation and the update may be performed about once a day. (3) It is determined whether or not a collision factor is present based on the created unique identifier list, and the collision factor is stored in the unique identifier of the right turn lane.

In the control system pertaining to the reduction in blind spot accidents, it is confirmed whether or not a motorbike, a bicycle, or a person is present in each area, and the result is stored as an element of a structure of an associated unique identifier list header, which is used as blind spot information.

As the blind spot information, information stored in the result as elements of the structure of the associated unique identifier list header is four types of −1, 0, 1, and 2. “−1” indicates no information. “0” indicates that information is acquired, a motorcycle, a bicycle, a person, or the like is not present, and safety travel is possible.

“1” indicates that a bike, a bicycle, or a person is present in the acquired information, but there is no problem in terms of timing, and therefore, if attention is paid, travelling is possible. “2” indicates that a motorcycle, a bicycle, a person, or the like is present in the acquired information, and the vehicle should not temporarily travel because of a possibility of collision in terms of timing.

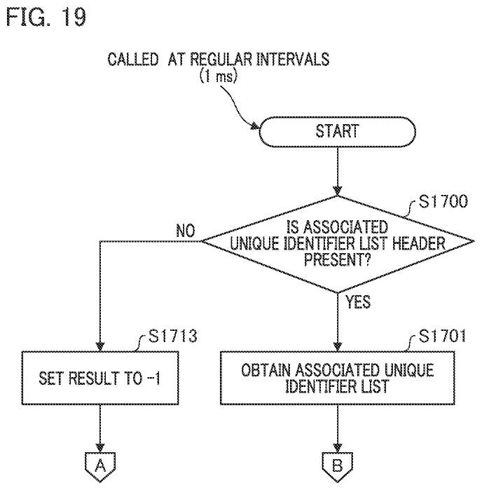

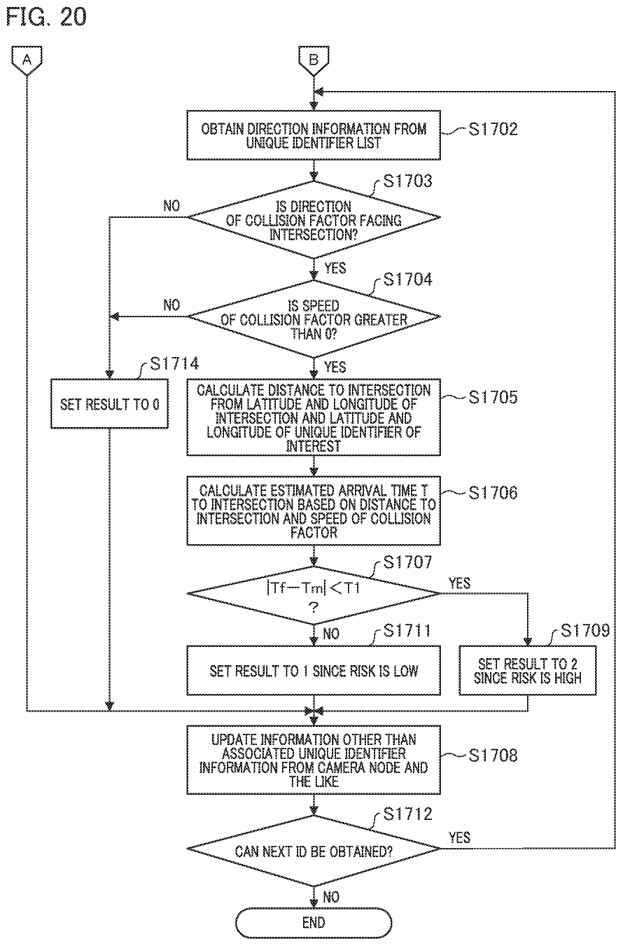

FIG. 19 is a diagram that explains a sequence in which the conversion information holding device 14 updates the result of the associated unique identifier list header associated with the unique identifier of the right turn lane. FIG. 20 is a diagram that explains a sequence in which the conversion information holding device 14 updates the result of the associated unique identifier list header associated with the unique identifier of the right turn lane, and is a diagram showing a continuation of FIG. 19.

In the second embodiment, the conversion information holding device 14 updates the unique identifier of the right turn lane at an interval of 1 [ms]. In step S1700, the conversion information holding device 14 determines whether or not the associated unique identifier list header is associated with the unique identifier of the right turn lane. Specifically, the conversion information holding device 14 refers to the related unique identifier information of the Table 1203, and determines whether or not there is head address information.

When there is the head address information in the associated unique identifier information, the conversion information holding device 14 determines that the associated unique identifier list header is associated with the unique identifier of the right turn lane. If there is no head address information in the associated unique identifier information, the conversion information holding device 14 determines that the associated unique identifier list header is not associated with the unique identifier of the right turn lane.

In a case in which the conversion information holding device 14 determines that the associated unique identifier list header is associated with the unique identifier of the right turn lane, the process of step S1701 is executed. In a case in which the conversion information holding device 14 determines that the associated unique identifier list header is not associated with the unique identifier of the right turn lane, the process of step S1713 is executed.

In step S1713, the conversion information holding device 14 sets the result of the associated unique identifier list header to −1. Subsequent to the process in step S1713, the conversion information holding device 14 executes the process in step S1708 of FIG. 20. The process in step S1708 will be described below.

In step S1701, the conversion information holding device 14 refers to the associated unique identifier list header stored in the related unique identifier information, and acquires the head address of the unique identifier list.

In step S1702 of FIG. 20 subsequent to step S1701, the conversion information holding device 14 acquires a unique identifier for an area in which a motorcycle, bicycle, a person, or the like is searched in the unique identifier list.

The conversion information holding device 14 acquires direction information of dynamic information of the collision factor to be searched for each area. As described above, since the dynamic information in Table 1203 of FIG. 14 is listed in the unique identifier list, the conversion information holding device 14 can acquire the direction information of the collision factor.

In step S1703, the conversion information holding device 14 confirms the direction of the collision factor based on the direction information of the collision factor, and determines whether or not the collision factor is directed toward the intersection. In the case in which the conversion information holding device 14 determines that the collision factor is directed toward the intersection, the conversion information storage device 14 determines that the collision factor may enter the intersection, and the process of step S1704 is executed.

In the case in which the conversion information holding device 14 determines that the collision factor does not directed toward the direction of the intersection, it is determined that the collision factor does not enter the intersection, and the process of step S1714 is executed.

In step S1714, the conversion information holding device 14 sets the result of the associated unique identifier list header to 0. The conversion information holding device 14 executes the process of step S1708 subsequent to the process of step S1714. The process in step S1708 will be described below.

In step S1704, the conversion information holding device 14 determines whether or not the speed of the collision factor is greater than 0. In a case in which the conversion information holding device 14 determines that the speed of the collision factor is 0, that is, when the vehicle is stopped, it is determined that the vehicle is parked and the collision factor does not enter the intersection, and the process of step S1714 is executed.

In a case in which the conversion information holding device 14 determines that the speed of the collision factor is greater than 0, it is determined that there is a possibility that the collision factor enters the intersection, and the process of step S1705 is executed.

In step S1705, the conversion information holding device 14 calculates the distance D to the intersection from the collision factor, that is, the unique identifier of interest. The conversion information holding device 14 acquires the coordinates of the intersection from the road network data. In the unique identifier information of the unique identifier list, dynamic information and the position information of the unique identifier are stored. The conversion information holding device 14 calculates the distance D from the collision factor to the intersection by using these two pieces of information.

In step S1706, the conversion information holding device 14 calculates an estimation time Tf until the collision factor arrives at the intersection based on the distance D calculated in step S1705, the speed S of the collision factor, and the time difference Ts between the current time and the update time of the unique identifier. The conversion information holding device 14 acquires the speed S of the collision factor from the database. The conversion information holding device 14 calculates the estimation time Tf by Formula 5 below.

Tf=D/S−Ts (Formula 5)

Here, since the distance D is information older than the current time by Ts seconds, the time obtained by subtracting Ts seconds from the time obtained by dividing the distance D by the speed S is the time required from the current time for the collision factor to arrive at the intersection.

In step S1707, the conversion information holding device 14 determines the possibility of collision between the own vehicle and the collision factor by using the difference between Tf obtained in step S1706 and the expected time Tm for one's own vehicle to arrive at the intersection.

In a case in which the conversion information holding device 14 determines that the absolute value to the difference |Tf−Tm| between Tf and Tm is smaller than the threshold T1, it is determined that the possibility of collision is high, and the process of step S1709 is executed. In a case in which the conversion information holding device 14 determines that |Tf−Tm| is equal to or greater than the threshold T1, it is determined that the possibility of collision is low, and the process of step S1711 is executed. In the second embodiment, the threshold T1 is set to 10 seconds.

In step S1709, the conversion information holding device 14 sets the result of the associated unique identifier list header to 2 since the collision factor that is present in the unique identifier has a high risk of collision. The conversion information holding device 14 executes the process of step S1708 subsequent to the process of step S1709. The process in step S1708 will be described below.

In step S1711, the conversion information holding device 14 sets the result of the associated unique identifier list header to 1 since the collision factor that is present in this unique identifier has a low risk of collision. The conversion information holding device 14 executes the process of step S1708 subsequent to the process of step S1709.

In step S1708, the conversion information holding device 14 updates information other than the associated unique identifier information from the camera node and the like. This update is as described in the autonomous movable apparatus control system, and a description thereof will be omitted here.

In step S1712, the conversion information holding device 14 determines whether or not the next ID can be acquired in the unique identifier list, that is, whether or not the unique identifier to be searched for remains. In a case in which the conversion information holding device 14 determines that the next ID cannot be acquired, that is, the unique identifier to be searched for does not remain, the processes of FIG. 19 and FIG. 20 end.

In a case in which the conversion information holding device 14 determines that the next identifier can be acquired, that is, the unique identifier to be searched for remains, the process of step S1702 is executed.

In the second embodiment, a processing time of several hundred ms is assumed from the start to the end of the sequence of FIG. 19 and FIG. 20. Even when the sequences of FIG. 19 and FIG. 20 end, the sequences of FIG. 19 and FIG. 20 are repeatedly activated every time the unique identifier list is updated. Thus, the conversion information holding device 14, which is the server side, constantly updates the information of each area, and thus, it is possible to confirm the dynamic information of each area from the unique identifier of the right turn lane.

(4) The right-turn vehicle acquires the information on the collision factor from the unique identifier in the right-turn lane and determines the timing of the right turn.

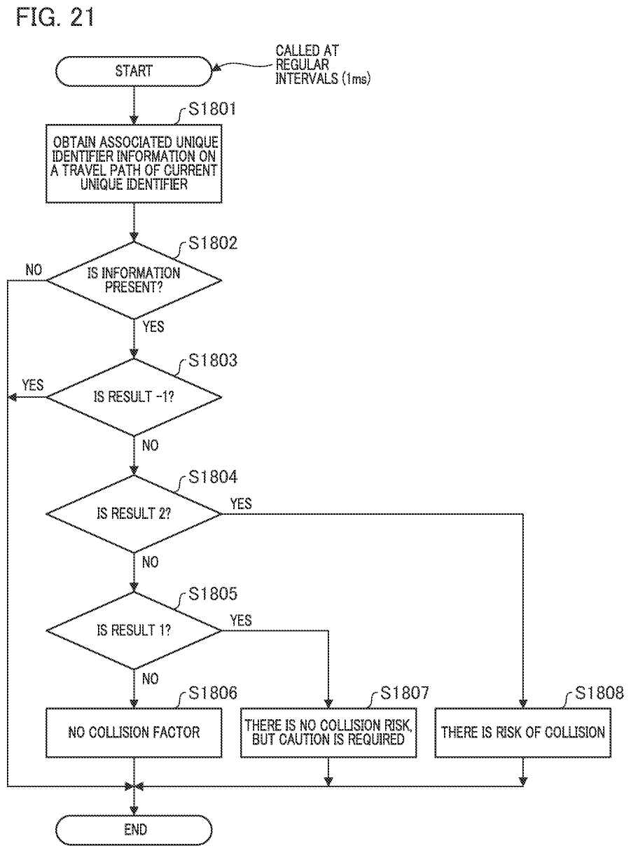

FIG. 21 is a diagram that explains a sequence executed by the control unit 12-2 of the autonomous movable apparatus 12. In the second embodiment, the autonomous movable apparatus 12 also executes the sequence of FIG. 21 at 1 ms intervals.

In step S1801, the control unit 12-2 acquires the information on the unique identifier of the current location of the autonomous movable apparatus 12, and confirms the associated unique identifier information therein.

In step S1802, the control unit 12-2 determines whether or not there is information on the unique identifier of the current location. In the case in which the control unit 12-2 determines that the information on the unique identifier of the current location is not present, the process of FIG. 21 ends. In the case in which the control unit 12-2 determines that the information on the unique identifier of the current location is present, the process of step S1803 is executed.

In step S1803, the control unit 12-2 determines whether or not the result of the associated unique identifier list header is −1. In the case in which the control unit 12-2 determines that the result of the associated unique identifier list header is not −1, the process of FIG. 21 ends. In the case in which the control unit 12-2 determines that the result of the associated unique identifier list header is not −1, the process of step S1804 is executed.

In step S1804, the control unit 12-2 determines whether or not the result of the associated unique identifier list header is 2. In the case in which the control unit 12-2 determines that the result of the associated unique identifier list header is 2, the process of step S1808 is executed. In the case in which the control unit 12-2 determines that the result of the associated unique identifier list header is not 2, the process of step S1805 is executed.

In step S1808, the control unit 12-2 determines that there is a risk of collision, and outputs a right turn stop command to the drive unit 12-6.

In step S1805, the control unit 12-2 determines whether or not the result of the associated unique identifier list header is 1. In the case in which the control unit 12-2 determines that the result of the associated unique identifier list header is 1, the process of step S1807 is executed. In the case in which the control unit 12-2 determines that the result of the associated unique identifier list header is not 1, the process of step S1806 is executed.

In step S1807, the control unit 12-2 performs control in consideration of a situation and a margin to the arrival time because there is no risk of collision but caution is required. Specifically, the control unit 12-2, for example, basically does not execute a right turn, and performs control to wait for the collision factor to disappear.

In step S1806, since there is no collision factor, the control unit 12-2 performs control to execute a right turn as it is.

As can be understood from the explanation in this item, the autonomous movable apparatus 12 can collect information on the blind spot area by referring to the unique identifier of the current location.

### <Method of Detecting Information on the Route in Advance Using an Autonomous Movable Apparatus Control System>

Here, a method of detecting information on a route to be traveled from now in advance (hereinafter, referred to as a “preliminary information detection method”) using the configuration described in the blind spot accident reduction method will be explained. Hereinafter, a route to be traveled may be simply referred to as a route.

The point of the mechanism of the blind spot accident reduction method described above is to acquire the road information from the road network data, automatically associate the related space information with each other, and grasp the situation of the route ahead in advance.

This mechanism can also be applied to a use of acquiring information on a route in advance in addition to the detection of a blind spot. The information on the route includes, for example, information on structures that is present on the route. Structures include, for example, bridges, tunnels, and parking on a highway.

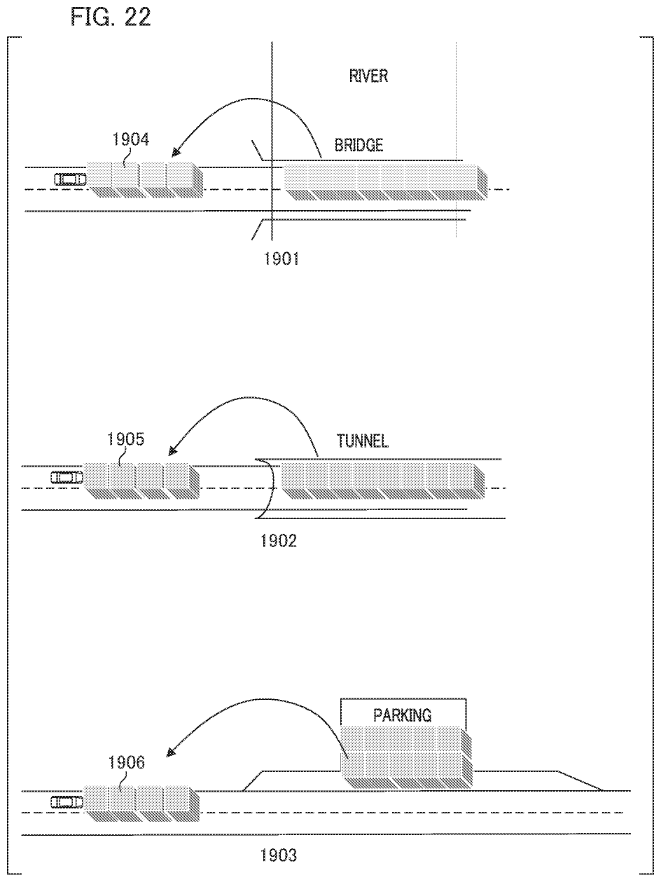

FIG. 22 is a diagram that explains an outline of the prior information detection method. A schematic diagram 1901 in the upper stage shows a state in which the information on the bridge is associated in advance with a unique identifier 1904 at the position of the movable apparatus traveling toward the bridge.

A schematic diagram 1902 in the middle stage shows a state in which information in a tunnel is associated in advance with a unique identifier 1905 at a position of a movable apparatus traveling toward the tunnel. A schematic diagram 1903 in a lower stage shows a state in which information on parking on a highway is associated in advance with a unique identifier 1906 at a position of a movable apparatus traveling toward parking on a highway.

Thus, the prior information detection method is a method of receiving information on a target in advance from a unique identifier at a position where the movable apparatus is traveling toward the target such as a bridge and a tunnel.

The configuration of the prior information detection method is such that, as in the blind spot accident reduction method, an item of associated unique identifier information is provided in the information of the unique identifier, and an associated unique identifier list header and an associated unique identifier list can be referred to.

The associated unique identifier information is Table 1203 of FIG. 14. The associated unique identifier list header is Table 1602 of FIG. 18. The associated unique identifier list is Table 1601 of FIG. 18. These are the same as those described in the blind spot accident reduction method, and thus detailed description thereof will be omitted here.

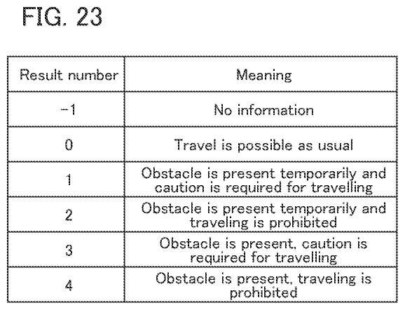

The difference from the blind spot accident reduction method is the difference in the meaning of the number used in the result of the associated unique identifier list header. FIG. 23 is a diagram that explains the types of the results of the associated unique identifier list header also including the blind spot accident reduction method.

The case in which the result numbers, which are the values of the results of the associated unique identifier list header are −1, 0, 1, and 2, this is the same as those explained in the above-described the blind spot accident reduction method. The case in which the result number is 3 indicates that there is an obstacle, and it is difficult to travel. The case in which the result number is 4 indicates that there is an obstacle, and it is not possible to travel.

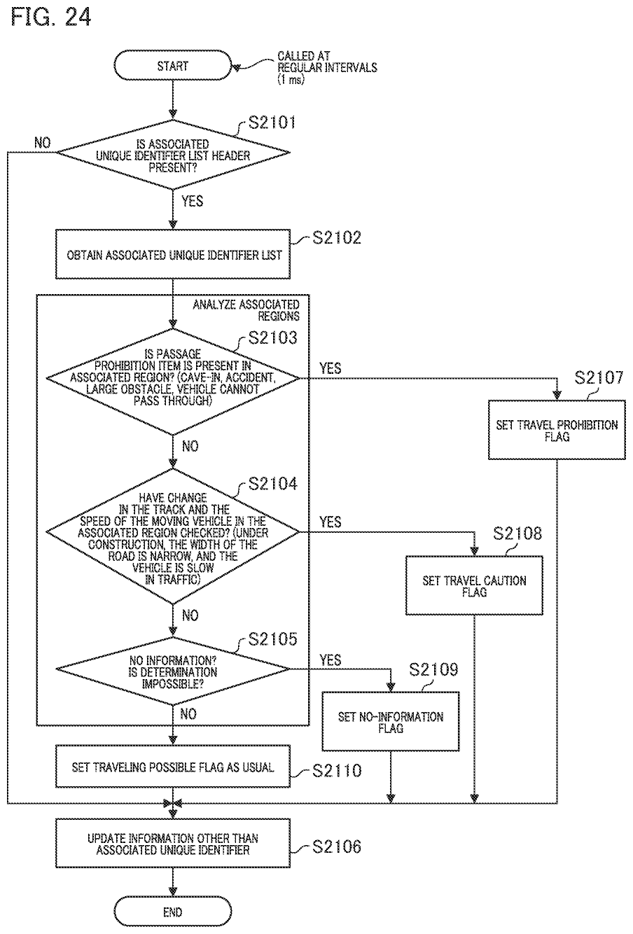

FIG. 24 is a diagram that explains a sequence in which the result numbers 3 and 4 are determined by the prior information detection method. Here, the tunnel of the schematic diagram 1902 of FIG. 22 will be described as an example.

The conversion information holding device 14 executes the process of step S2101 and subsequent steps at regular intervals (1 [ms] interval) in order to update the unique identifier 1905. In step S2101, the conversion information holding device 14 determines whether or not the associated unique identifier list header pointer is stored in the associated unique identifier information.

In the case in which the conversion information holding device 14 determines that the associated unique identifier list header pointer is stored in the associated unique identifier information, the process of step S2102 is executed. In the case in which the conversion information holding device 14 determines that the associated unique identifier list header pointer is not stored in the associated unique identifier information, the process of step S2106 is executed.

In step S2102, the conversion information holding device 14 acquires the associated unique identifier list registered in the associated unique identifier list header. In step S2103, the conversion information holding device 14 refers to individual unique identifier information from the acquired unique identifier list and determines whether or not an item for which passage is impossible is present.

The reason why the passage is impossible includes a heavy traffic jam, a large fallen object, and the like. The conversion information holding device 14 determines the heavy traffic jam by acquiring the traffic jam of the road information in the unique identifier. This information may be acquired from the road network data or may be determined in a case in which the speed of the automobile in the dynamic information of the unique identifier on the traffic road is 0 or a value close to 0.

Even for a large falling object, the conversion information holding device 14 may be the one obtained from the road network data or may be determined by other information in the dynamic information. In a case in which the conversion information holding device 14 determines that an item in which the passage is impossible is present, the process of step S2107 is executed. In a case in which the conversion information holding device 14 determines that an item in which the passage is impossible is not present, the process of step S2104 is executed.

In step S2107, the conversion information holding device 14 inputs 4, which is a value indicating that traveling is prohibited, to the result of the associated unique identifier list header in the unique identifier 1905. Subsequently, the conversion information holding device 14 executes the process of step S2106.

In step S2104, the conversion information holding device 14 determines whether or not there is a situation in which the vehicle cannot travel at a normal speed. The situation in which the vehicle cannot travel at a normal speed is that, for example, the road width is narrow or there are many parked vehicles.

The conversion information holding device 14 can acquire whether or not the road width is narrow from the road information in the unique identifier. The conversion information holding device 14 can determine whether or not a parked vehicle is present based on whether or not a vehicle at a speed of 0 is present even though there is no traffic jam, as the road situation in the unique identifier.

In the case in which the conversion information holding device 14 determines that the situation in which the vehicle cannot travel at a normal speed is present, the process of step S2108 is executed. In the case in which the conversion information holding device 14 determines that the situation in which the vehicle cannot travel at a normal speed is not present, the process of step S2105 is executed.

In step S2108, the conversion information holding device 14 inputs 3, which is a value that means caution to travel, to the result of the associated unique identifier list header in the unique identifier 1905. Subsequently, the conversion information holding device 14 executes the process of step S2106.

In step S2105, the conversion information holding device 14 determines whether or not the information in the unique identifier 1905 can be used to determine whether or not the vehicle can travel or whether or not there is no data in the unique identifier.

In the case in which the conversion information holding device 14 determines that there is no data in the unique identifier, and in a case in which the conversion information holding device 14 determines that there is data in the unique identifier but cannot determine whether or not the vehicle can travel based on the information in the unique identifier, the process of step S2109 is executed. In the case in which the conversion information holding device 14 determines that the vehicle can travel based on the information in the unique identifier, the process in step S2110 is executed.

In step S2109, the conversion information holding device 14 inputs −1, which means no information, to the result of the related unique identifier list header in the unique identifier 1905. Subsequently, the conversion information holding device 14 executes the process of step S2106.

In step S2110, the conversion information holding device 14 inputs 0, which means that the vehicle can travel as usual to the result of the associated unique identifier list header in the unique identifier 1905. Subsequently, the conversion information holding device 14 executes the process of step S2106.

In step S2106, the conversion information holding device 14 updates information other than the associated unique identifier information and ends the process. The conversion information holding device 14 updates the result of the associated unique identifier list header by executing the sequence as shown in FIG. 24.

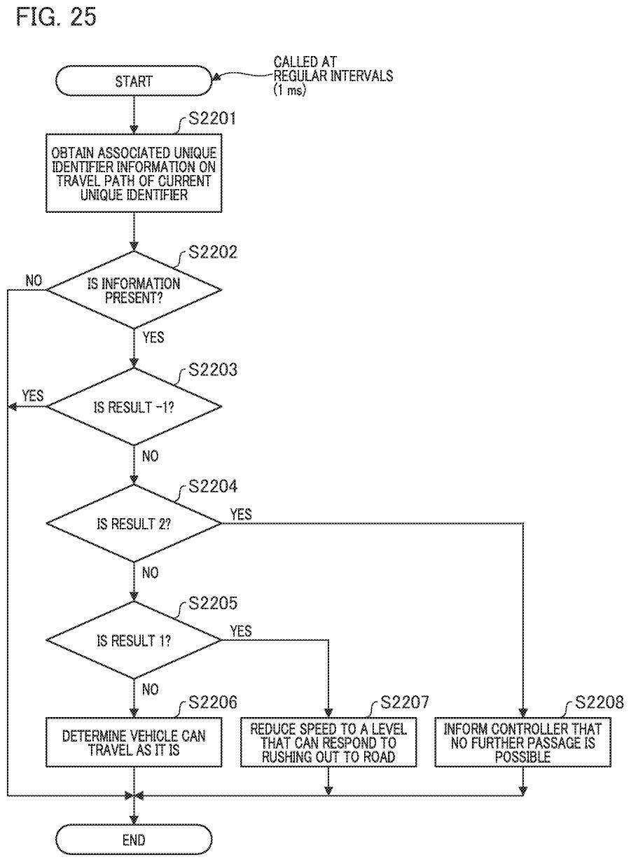

FIG. 25 is a diagram that explains a sequence executed by the control unit 12-2 of the autonomous movable apparatus 12 in the method of detecting the route information in advance. In the second embodiment, the autonomous movable apparatus 12 executes the sequence of FIG. 25 at the interval of 1 [ms].

In step S2201, the control unit 12-2 obtains information on the unique identifier at the current location, and obtains associated unique identifier information therein.

In step S2202, the control unit 12-2 determines whether or not there is associated unique identifier information in the information of the unique identifier at the current location. In the case in which the control unit 12-2 determines that there is associated unique identifier information in the information of the unique identifier at the current location, the process of step S2203 is executed. In the case in which the control unit 12-2 determines that there is no associated unique identifier information in the information of the unique identifier at the current location, the process of FIG. 25 ends.

In step S2203, the control unit 12-2 determines whether or not the result of the associated unique identifier list header is −1. In the case in which the control unit 12-2 determines that the result of the associated unique identifier list header is −1, the process of FIG. 25 ends. In the case in which the control unit 12-2 determines that the result of the associated unique identifier list header is not −1, the process of step S2204 is executed.

In step S2204, the control unit 12-2 determines whether or not the result of the associated unique identifier list header is 2. In the case in which the control unit 12-2 determines that the result of the associated unique identifier list header is 2, the process of step S2208 is executed. In the case in which the control unit 12-2 determines that the result of the associated unique identifier list header is not 2, the process of step S2205 is executed.

In step S2205, the control unit 12-2 determines whether or not the result of the associated unique identifier list header is 1. In the case in which the control unit 12-2 determines that the result of the associated unique identifier list header is 1, the process of step S2207 is executed. In the case in which the control unit 12-2 determines that the result of the associated unique identifier list header is not 1, the process of step S2206 is executed.

In step S2208, the control unit 12-2 determines that an event in which the vehicle cannot travel has occurred on the route, and transmits information indicating that the vehicle cannot move forward to the control unit 10-2 of the system control device 10. The control unit 10-2 receives the information and determines whether not to change the route or stop traveling. The system control device 10 transmits the determination result to the autonomous movable apparatus 12. The autonomous movable apparatus 12 receives the determination result of the system control device 10 and executes route change or stop traveling. Subsequently, the process ends.

In step S2207, the control unit 12-2 determines that there are many obstacles and caution is required, and performs control to reduce the speed of the autonomous movable apparatus 12 to a speed at which the autonomous movable apparatus 12 can respond to rushing out to a road, and the like. Subsequently, the process ends.

In step S2206, the control unit 12-2 can travel as usual, and therefore, the travelling is continued as is. Subsequently, the process ends.

As can be understood from the description in this item, the autonomous movable apparatus 12 can acquire information ahead on the route by referring to the unique identifier at the current location, and can change traveling in advance.

As described above, the embodiments of the blind spot accident reduction method and the prior information detection method using the autonomous movable apparatus control system have been described.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the control system and the like through a network or various storage media. Then, a computer (or a CPU, an MPU, or the like) of the control system and the like may be configured to read and execute the program. In such a case, the program and the storage medium storing the program configure the present invention.

Additionally, the present invention includes those realized using, for example, at least one processor or circuit configured to function of the embodiments explained above. Note that distributed processing may be performed using a plurality of processors.

This application claims the benefit of priority from Japanese Patent Application No. 2023-074797, filed on Apr. 28, 2023, which is hereby incorporated by reference herein in its entirety.

What is claimed is:

1. A control system comprising:
at least one processor or circuit configured to function as:
a control unit configured to issue a control instruction to at least one autonomous movable apparatus; and
a conversion information holding unit configured to convert spatial information including information on a type of an object that is present in a space defined by latitude, longitude, and height and information on time into a format in association with a first unique identifier and hold the spatial information,
wherein the first unique identifier is stored so that information on a second unique identifier that is different from the first unique identifier and is associated with the first unique identifier can be referred to.

2. The control system according to claim 1, wherein the control unit issue the control instruction referring to information on the second unique identifier that is associated with the first unique identifier.

3. The control system according to claim 1, wherein the second unique identifier includes information on a route of an autonomous movable apparatus that is present at a position indicated by the spatial information associated with the first unique identifier.

4. The control system according to claim 1, wherein the second unique identifier includes information on an intersection toward which an autonomous movable apparatus that is present at a position indicated by the spatial information associated with the first unique identifier is heading.

5. The control system according to claim 1, wherein the second unique identifier includes information on a structure on a route of the autonomous movable apparatus that is present at a position indicated by the spatial information associated with the first unique identifier.

6. A control method comprising:
performing control to issue a control instruction to at least one autonomous movable apparatus; and
performing conversion information holding in which spatial information including information on a type of an object that is present in a space defined by latitude, longitude, and height and information on time is converted into a format in association with a first unique identifier and the spatial information is held,
wherein the first unique identifier is stored so that information on a second unique identifier that is different from the unique identifier and is associated with the first unique identifier can be referred to.

7. A non-transitory computer-readable storage medium configured to store a computer program comprising instructions for executing following processes:
performing control to issue a control instruction to at least one autonomous movable apparatus; and
performing conversion information holding in which spatial information including information on a type of an object that is present in a space defined by latitude, longitude, and height and information on time is converted into a format in association with a first unique identifier and the spatial information is held,
wherein the first unique identifier is stored so that information on a second unique identifier that is different from the first unique identifier and is associated with the first unique identifier can be referred to.
